(19) United States
(12) Patent Application Publication
(10) Pub. No.: US 2024/0273878 A1
(43) Pub. Date: Aug. 15, 2024

(54) APPARATUS TO ANALYZE FAILURE MODES OF MACHINE LEARNING COMPUTER VISION MODELS

(71) Applicant: Akridata, Inc., Los Altos, CA (US)

(72) Inventors: Sabarish Vadarevu, Bengaluru (IN); Rakshith Sundaraiah, Bengaluru (IN); Ajith Kumar Battaje, Bengaluru (IN); Saurabh Manchanda, Bengaluru (IN); Azhar Mohammad, Bengaluru (IN); Vijay Karamcheti, Los Altos, CA (US)

(73) Assignee: Akridata, Inc., Los Altos, CA (US)

(21) Appl. No.: 18/583,866

(22) Filed: Feb. 22, 2024

Related U.S. Application Data
(63) Continuation of application No. 18/508,219, filed on Nov. 13, 2023.

(51) Int. Cl. G06V 10/776; G06F 3/04842; G06F 3/04847; G06F 11/36; G06T 11/20; G06V 10/762; G06V 10/764; G06V 10/94

(52) U.S. Cl. CPC G06V 10/776; G06F 11/3684; G06T 11/206; G06V 10/762; G06V 10/764; G06V 10/945; G06F 3/04842; G06F 3/04847; G06T 2200/24

(57) ABSTRACT

Methods and systems are disclosed to enable users to analyze failure modes of computer vision machine learning models using error featurization. In one embodiment, an image classification model is expressed in a scatter plot of prediction errors over a labeled dataset. A user interface allows practitioners to identify patterns in data that cause the model to fail and supports high precision analysis of critical failure modes of trained machine learning (ML) models. The embodiment helps ML practitioners improve their curation, labeling, and training processes. The embodiments allow ML practitioners to choose the most relevant data for subsequent improvement of an ML model. The highly targeted data curation leads to a multifold reduction in costs and time for labeling and training data.

### CROSS-REFERENCE TO RELATED APPLICATIONS

This non-provisional United States (U.S.) patent application is a continuation and claims the benefit of U.S. non-provisional patent application Ser. No. 18/508,219 titled SYSTEMS AND METHODS TO ANALYZE FAILURE MODES OF MACHINE LEARNING COMPUTER VISION MODELS USING ERROR FEATURIZATION filed on Nov. 13, 2023, by inventors Sabarish Vadarevu, et al., incorporated herein, for all intents and purposes. U.S. non-provisional patent application Ser. No. 18/508,219 claims the benefit of U.S. provisional patent application No. 63/424,714 titled SYSTEMS AND METHODS TO ANALYZE FAILURE MODES OF MACHINE LEARNING COMPUTER VISION MODELS USING ERROR FEATURIZATION filed on Nov. 11, 2022, by inventors Sabarish Vadarevu, et al., incorporated herein, for all intents and purposes.

### FIELD

The disclosed embodiments relate generally to the field of computer vision in supervised machine learning, and more specifically to interactive graphical representations of model performance—thus enabling curation of high-quality data for subsequent model improvement.

### BACKGROUND

As machine learning (ML) becomes more popular and powerful, the deployment of ML models is expanding from isolated and niche environments to more generic and complex environments. The data used to train ML models should keep up with this expansion; because the performance of an ML model is directly dependent on the quality of the training data used to train the ML model.

While data acquisition has become cheaper with the advent of high-fidelity sensors, such as higher resolution image cameras, the process of labeling object data still remains a manual labor-intensive process. This holds true in spite of the availability of several tools that simplify the manual labeling process and provide reasonable prior labeled objects. Labeling tools still require a human to act on these prior labeled objects to produce the final labels and are therefore time-consuming and expensive.

ML models are rarely 100% accurate and refining them to be more accurate is an iterative and ongoing process. However, some prediction failures are costlier than others. For instance, a computer vision model for a self-driving car mispredicting the colors of cars may be acceptable, while the same computer vision model mispredicting the colors of traffic lights will be devastating. ML practitioners or data engineers can perform risk assessments of deploying their ML model, based on the relative frequency and impact of each failure mode. The most critical failure modes of an ML model should be identified by the ML practitioner. With critical failure modes of an ML model, ML practitioners can then channel more resources—for acquisition, labeling, and training—into fixing these critical failure modes of the ML model.

ML practitioners should audit the performance of their ML models to visualize and analyze model prediction failures. Such failure analysis of ML model predictions must be conducted simultaneously for multiple failure modes to evaluate their relative risks. For critical failures, practitioners should be able to search for common patterns among the data samples where the ML model fails.

### SUMMARY

The embodiments are best summarized by the claims below. However in some aspects, the techniques described herein relate to a method for verification and analysis of artificial intelligence (AI) models, the method including: selecting a test data set of images with each datapoint annotated with a unique identification; receiving ground truth annotation associated with each image in the test data set; receiving a fitted AI model to be verified and analyzed; running the fitted AI model on the test data set using an Al server to receive output data regarding each image in the test data set; for each image of the plurality of images in the test data set, featurizing the output data, the ground truth, and the image to generate an output feature vector; and reducing and clustering the plurality of output feature vectors together to generate a two-dimensional scatter plot and cluster information of a plurality of data points.

In some aspects, the techniques described herein relate to a method, further including supporting an interactive user interface to explore, browse, and analyze one or more of the data points in the two-dimensional scatter plot.

In some aspects, the techniques described herein relate to a method, further including in response to hovering a device input on a data point in the scatter plot (in a manual mode), displaying the underlying image, the ground truth annotation, and the resultant output of running the fitted model on the image associated with the data point.

In some aspects, the techniques described herein relate to a method, further including in response to clicking on a data point with a device input in the scatter plot, displaying a plurality of images in the cluster; and in response to hovering over one of the plurality of images with the user interface device, displaying the ground truth annotation and the resultant output of running the fitted model on the hovered image associated with a data point in the cluster.

In some aspects, the techniques described herein relate to a method, further including in response to clicking an icon (e.g., bidirectional arrow) on one of the plurality of images with the user interface device, displaying a high-resolution image and any annotations on the image and entries in the resultant model output for the image.

In some aspects, the techniques described herein relate to a method, further including in response to clicking on a data point in a cluster, displaying a plurality of images sampled from datapoints in the cluster; and in response to hovering over one of the plurality of images with the user interface device, displaying the ground truth annotation and the resultant output of running the fitted model on the hovered image associated with a data point in the cluster.

In some aspects, the techniques described herein relate to a method, further including in response to clicking an icon on one of the plurality of images with the user interface device, displaying a high-resolution image and any annotations on the image and entries in the resultant model output for the image.

In some aspects, the techniques described herein relate to a method, further including: in response to clicking on a sequence of a plurality of data points in a cluster, (manual mode cluster trajectory) displaying a plurality of images corresponding to the sequence of selected plurality of datapoints in the cluster; and in response to hovering over one of the plurality of images with the user interface device, displaying the ground truth annotation and the resultant output of running the fitted model on the hovered image associated with a data point in the cluster.

In some aspects, the techniques described herein relate to a method, further including In response to clicking an icon (e.g., bidirectional arrow) on one of the plurality of images with the user interface device, displaying a high-resolution image and any annotations on the image (boxes around objects or labels) and entries in the resultant model output for the image.

In some aspects, the techniques described herein relate to a method, wherein: the AI model is an image classification model, the ground truth annotation includes a single class of a plurality of classes; and the model output includes prediction confidence scores for each of the plurality of classes.

In some aspects, the techniques described herein relate to a method, wherein the featurization further includes: a class-wise evaluation of the divergence between ground truth class-labels and model prediction confidences in the case of image classification.

In some aspects, the techniques described herein relate to a method, wherein the featurization further includes: a test dataset of images, with each data sample in the dataset assigned a ground truth class-label provided by expert annotators; and model predictions for the AI model being evaluated/analyzed obtained by running inferences on the test data to obtain prediction confidences.

In some aspects, the techniques described herein relate to a method, wherein: the AI model is an object detection model, the ground truth annotation includes zero or more object class and bounding boxes; and the model output includes a zero or more object class and bounding boxes, along with a prediction confidence score associated with each predicted box.

In some aspects, the techniques described herein relate to a method, wherein the featurization further includes: a class-wise and a region-wise evaluation of divergence between ground truth object bounding boxes and model prediction bounding boxes.

In some aspects, the techniques described herein relate to a method, wherein the featurization further includes: a test dataset of images, with each data sample in the dataset assigned ground truth labels including zero or more annotations, each containing an object class and bounding box; and model predictions for the AI model being evaluated/analyzed obtained by running inferences on the test data to obtain zero or more prediction annotations, each containing an object class, bounding box, and an associated prediction confidence.

In some aspects, the techniques described herein relate to a method, wherein the reducing and clustering includes: selecting a clustering algorithm to group data points together from the group comprising HDBSCAN, K-Segmentation, Hierarchical K-Means, and Gaussian Mixture Model; selecting an embedding algorithm to plot and display the data points in two dimensions from the group consisting of UMAP, principal component analysis (PCA), Locally Linear Embedding; and selecting an order of whether the embedding happens before clustering or clustering of data points happens before the embedding.

In some aspects, the techniques described herein relate to a method, wherein the UI further includes selecting one cluster of a plurality of data points; and splitting the one cluster into two or more subclusters of a two or more plurality of data points.

In some aspects, the techniques described herein relate to a method, wherein the UI further includes Selecting one cluster of a plurality of data points; and Merging the one cluster into a parent cluster of a plurality of data points.

In some aspects, the techniques described herein relate to a method, wherein the UI further includes In response to selecting and displaying a plurality of images in a cluster; Storing the plurality of images, the ground truth annotation, and the resultant model output into a storage device for further analysis.

In some aspects, the techniques described herein relate to a method, wherein: the reducing and clustering operates on a subset of features of the output feature vector associated with each image.

In some aspects, the techniques described herein relate to an apparatus for verification and analysis of artificial intelligence (AI) models, the apparatus including: a display device having a display screen that is configured to display a first user interface including a scatter plot window showing an aggregate view of a plurality of data points associated with images forming a scatter plot; and a plurality of statistical charts providing information about prediction performance of an AI model over the images.

In some aspects, the techniques described herein relate to an apparatus, wherein the first user interface further displays: a data view window showing a plurality of images each having one or more associated machine learning labels based on a selection of one or more data points in the scatter plot or a selection of data in a statistical chart.

In some aspects, the techniques described herein relate to an apparatus, wherein: the AI model is of classification type and the plurality of statistical charts includes one or more of the group consisting of an interactive bar chart of histograms illustrating prediction confidences; an interactive line plot of precision versus recall; and an interactive matrix plot (heatmap) for the confusion matrix.

In some aspects, the techniques described herein relate to an apparatus, wherein: the first UI further displays a slider menu to select a range of prediction confidence thresholds; and wherein a selection of the slider menu results in changes to the interactive line plot of precision versus recall and the interactive matrix plot for the confusion matrix to correspond to the images whose prediction confidence falls within the selected range.

In some aspects, the techniques described herein relate to an apparatus, wherein: the AI model is of object detection type and the plurality of statistical charts includes one or more of the group consisting of an interactive matrix plot illustrating prediction confidences versus intersection over union (IoU) scores; an interactive line plot of precision versus recall; and an interactive matrix plot (heatmap) for the confusion matrix.

In some aspects, the techniques described herein relate to an apparatus, wherein: the first UI further displays a first slider menu to select a first range of prediction confidence thresholds and a second slider menu to select a second range of IoU score thresholds; wherein a selection of the first slider menu results in changes to the interactive line plot of precision versus recall and the interactive matrix plot for the confusion matrix to correspond to images whose prediction confidence falls within the first range; and wherein a selection of the second slider menu results in further changes to the interactive line plot of precision versus recall and the interactive matrix plot for the confusion matrix to correspond to images whose IoU score threshold falls within the second range.

In some aspects, the techniques described herein relate to an apparatus, wherein: the plurality of data points are shown clustering together in clusters based on distances between image features.

In some aspects, the techniques described herein relate to an apparatus, wherein: the image features are determined by a class-wise evaluation of the divergence between ground truth class-labels and model prediction confidences in the case of image classification.

In some aspects, the techniques described herein relate to an apparatus, wherein: the image features are determined by the content of the images.

In some aspects, the techniques described herein relate to an apparatus, wherein: the one or more associated machine learning labels includes at least one classification label.

In some aspects, the techniques described herein relate to an apparatus, wherein: the one or more associated machine learning labels includes at least one object class and location label.

In some aspects, the techniques described herein relate to an apparatus, wherein: the one or more associated machine learning labels includes a ground truth label, a predicted label, or both a ground truth label and a predicted label.

In some aspects, the techniques described herein relate to an apparatus, wherein: the scatter plot window further includes an inset window including a legend with interactive buttons to control the scatter plot of the data points.

In some aspects, the techniques described herein relate to an apparatus, wherein: the scatter plot window further includes a plurality of option buttons to filter, sample, and view images corresponding to the data points in the scatter plot.

In some aspects, the techniques described herein relate to an apparatus, wherein: the data view window further includes associated with each image of the plurality of images, a plurality of differing selectable user interface icons (e.g., bidirectional arrow) displayed near each image to form a user interface (UI) card; wherein each differing selectable user interface icon of each user interface card supports additional user interface actions including removing a user interface card, enlarging the image of the user interface card, displaying associated labels of the user interface card, and marking the image of the user interface card as a sample of interest.

In some aspects, the techniques described herein relate to an apparatus, wherein: the data view window further includes a plurality of control buttons to control the number of UI cards, resetting UI cards, highlighting the corresponding samples in the scatter plot, and controlling the samples that get populated into the UI cards.

In some aspects, the techniques described herein relate to an apparatus, wherein: a selectable user interface icon of a UI card is selected that enlarges the image of the user interface card, the first user interface displays a high-resolution image; and annotations on the high-resolution image; and detailed parameters of the prediction performance of the AI model for the selected image.

In some aspects, the techniques described herein relate to an apparatus, wherein: the selection of data in a statistical chart includes the selection of a bar in an interactive bar chart of histograms illustrating prediction confidences.

In some aspects, the techniques described herein relate to an apparatus, wherein: the selection of data in a statistical chart includes the selection of a row, a column, the diagonal, or an individual cell in an interactive matrix plot (heatmap) for the confusion matrix.

In some aspects, the techniques described herein relate to an apparatus, wherein: the selection of data in a statistical chart includes the selection of a cell in an interactive matrix plot illustrating prediction confidences versus intersection over union (IoU) scores.

In some aspects, the techniques described herein relate to an apparatus, wherein: the selection of data in a statistical chart includes the selection of a row, a column, the diagonal, or an individual cell in an interactive matrix plot (heatmap) for the confusion matrix.

In some aspects, the techniques described herein relate to an apparatus. further including the display device having a display screen that is configured to display a second user interface window including a collapsible sidebar with buttons to navigate to different user interface windows to view and add datasets, and to view and add model analysis jobs.

In some aspects, the techniques described herein relate to an apparatus, further including: the display device having a display screen that is configured to display a third user interface window including a plurality of UI cards displaying information on existing datasets; with each UI card containing name and details of existing datasets; and a UI button to add a new dataset.

In some aspects, the techniques described herein relate to an apparatus, further including: the display device having the display screen that is configured to display a fourth user interface window including a pull-down menu for selection of one of a plurality of database catalog columns; a table displaying the values in a database catalog; and a button to visualize the model performance associated with the table as a model analysis job.

In some aspects, the techniques described herein relate to an apparatus, further including: the display device having the display screen that is configured to display a fifth user interface window including several pull down menus to select job parameters and database columns;

In some aspects, the techniques described herein relate to an apparatus, further including: the display device having the display screen that is configured to display a sixth user interface window including a plurality of UI cards displaying information on existing model analysis jobs; with each UI card containing name and details of existing jobs; three pulldown menus to filter the jobs; and a UI button in each UI card to visualize the corresponding model analysis job.

### BRIEF DESCRIPTION OF THE FIGURES

This patent or application file contains at least one drawing executed in color. Copies of this patent or patent application publication with color drawing(s) will be provided by the United States Patent and Trademark Office upon request and payment of the necessary fee.

FIG. 1 illustrates a block diagram of an image analysis system implemented with an image processor having one or more artificial intelligence machines (AIM) with one or more machine learning models.

FIG. 2A is a functional block diagram of an iterative training/refinement process for a machine learning model for the machine learning system of FIG. 1.

FIG. 2B is a functional block diagram of the model analysis process shown in FIG. 2A for the machine learning model.

FIG. 2C is a functional block diagram of the model analysis process shown in FIG. 2A, similar to FIG. 2B, but with inference happening external to the model analysis platform.

FIG. 3 is one user interface window generated by the model analysis system on a display device.

FIG. 4A is another user interface window generated by the model analysis system when the user interacts with the scatter-plot window by hovering on a data point with a user interface input device.

FIG. 4B is the analogue of 4A, corresponding to the problem of object detection.

FIG. 5A is another user interface window generated by the model analysis system when the user interacts with the scatter-plot window by clicking on a data point.

FIG. 5B is the analogue of 5A, corresponding to the problem of object detection.

FIG. 5C is a user interface window generated by the model analysis system when the user interacts with the data view window by clicking the ‘expand’ button for any data sample.

FIG. 6A is yet another user interface window generated by the model analysis system that includes an overlaid window that highlights the data points for which images and labels are shown in the data view window.

FIG. 6B is the analogue of 6A, corresponding to the problem of object detection.

FIG. 7A is a user interface window generated by the model analysis system by clicking on the ‘up arrow’ button in the scatter plot window to focus on the statistics view window.

FIG. 7B is a user interface window generated by the model analysis system by scrolling down on the statistics view window to get to the confusion matrix window.

FIG. 7C is a user interface window within the statistics view window showing the prediction histogram for the dataset.

FIG. 7D is a user interface window within the statistics view window showing the precision-recall curve for the dataset.

FIG. 7E is a user interface window within the statistics view window showing the confusion matrix for the dataset.

FIG. 8A is the homepage window for the user interface of the model analysis platform.

FIG. 8B is a user interface window generated by the model analysis system on a display device when a user clicks on the ‘Datasets’ button in the homepage. This window lists all datasets that a user has previously uploaded to the system.

FIG. 8C is a user interface window generated by the model analysis system when a user clicks on the ‘Add dataset’ button in the dataset view window.

FIG. 9A illustrates a label input file provided by the user in the Comma-Separated Values format to the model analysis system.

FIG. 9B is a user interface window generated by the model analysis system when the user clicks the ‘show catalog’ button in the dataset view window.

FIG. 9C is the analogue of FIG. 9B, corresponding to the problem of object detection.

FIG. 10A is a user interface window generated by the model analysis system when the user clicks the ‘Visualize’ button in the catalog view window to create a model analysis job.

FIG. 10B is a user interface window generated by the model analysis system when the user clicks the ‘Create’ button in the job creation window.

FIG. 10C is a user interface window generated by the model analysis system by clicking on the ‘Columns’ button in the job submission window, or by clicking ‘Next’ in the basic parameter selection window of the job submission window.

FIG. 10D is a user interface window generated by the model analysis system by clicking on the ‘Advanced Options’ button in the job submission window, or by clicking ‘Next’ in the column selection window of the job submission window.

FIG. 10E is a user interface window generated by the model analysis system by clicking on the ‘Jobs’ button in the homepage window of the model analysis platform. This window lists all of the previously submitted visualization jobs by a user.

FIG. 11A illustrates the method of assigning feature dimensions for error-featurization in object detection problems.

FIG. 11B illustrates an annotated data sample for object detection, showing the annotated bounding boxes and classes, along with an overlay of tiling of the image.

FIG. 12A illustrates the method of calculating overlaps between ground truth annotations and feature dimensions, predicted annotations and feature dimensions, and ground truth and predicted annotations.

FIG. 12B illustrates the method of calculating errors from overlaps and aggregating them together to assign final values to each feature dimension.

FIG. 13 illustrates a block diagram of a client-server computer system with multiple client computers communicating with one or more computer servers in a server center (or the cloud) over a computer network, such as a wide area network of the internet.

FIG. 14 illustrates a block diagram of a computer system for use as a server computer and client computers (devices) in the system shown in FIG. 13.

### DETAILED DESCRIPTION

In the following detailed description of the disclosed embodiments, numerous specific details are set forth in order to provide a thorough understanding. However, it will be obvious to one skilled in the art that the disclosed embodiments may be practiced without these specific details. In other instances, well known methods, procedures, components, and subsystems have not been described in detail so as not to unnecessarily obscure aspects of the disclosed embodiments. The phrases machine learning and artificial intelligence are used interchangeably herein such as in the case of a machine learning model and an artificial intelligence. The phrases ‘model analysis platform’ and ‘model analysis system’ are used interchangeably.

The disclosed embodiments include a method, apparatus, and system for verification and analysis of artificial intelligence (AI) models, including analyzing failure modes of machine learning (ML) models. In one embodiment, a platform is provided to facilitate failure analyses of ML models using error featurization. In some embodiments, the ML models are computer vision models, and the input data are digital images.

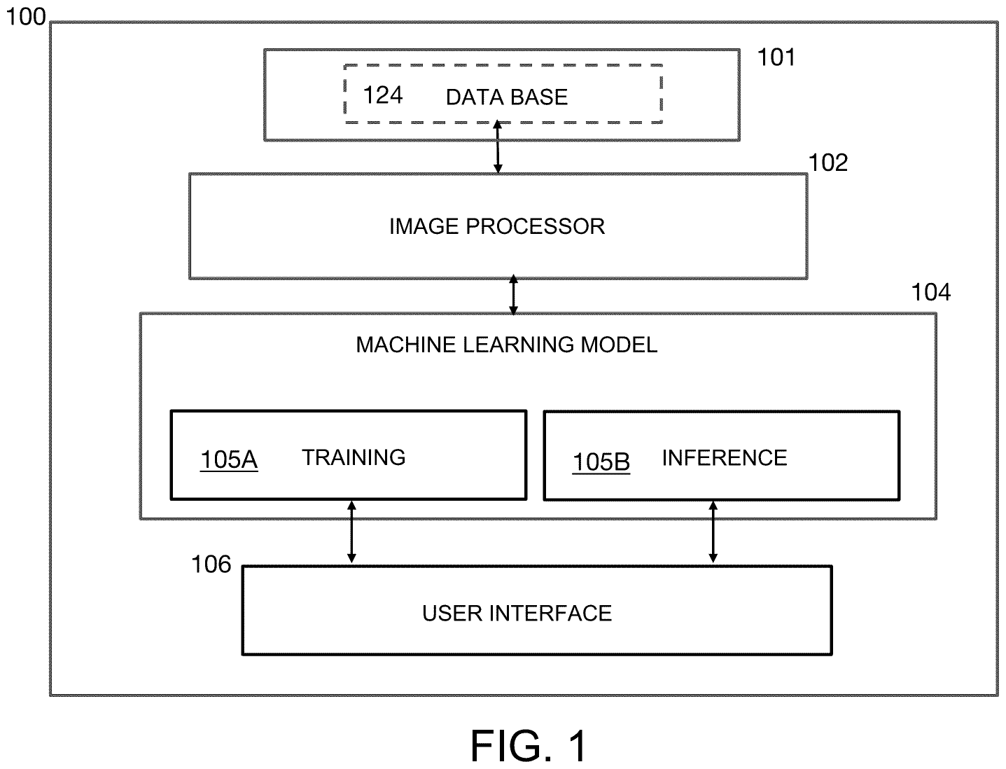

Referring now to FIG. 1, a high-level block diagram of an analysis system 100 is shown that utilizes machine learning to perform image analysis. The system 100 includes an image processor 102, a machine learning (AI) model 104 that can be either trained or used for classification/analysis, and a user interface 106. The machine learning (AI) model 104 can be trained for use with one or more machine learning algorithms (including image processing algorithms) and then used with the one or more machine learning algorithms for classification/analysis of objects within images.

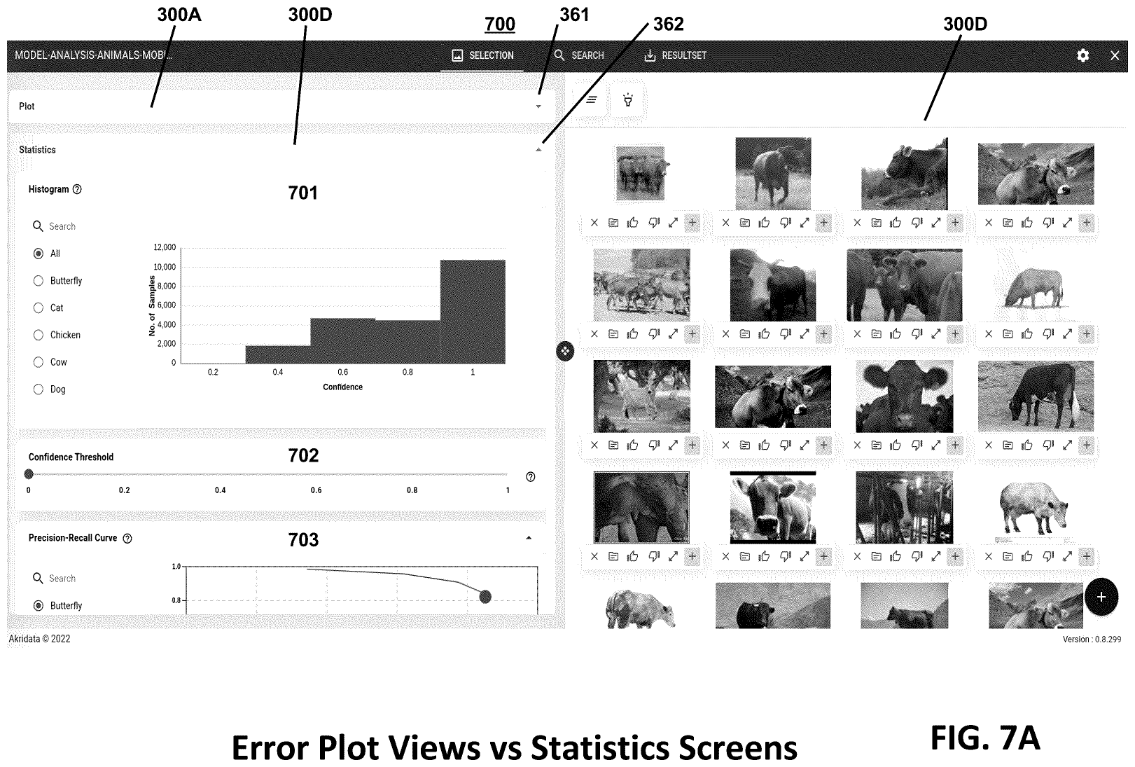

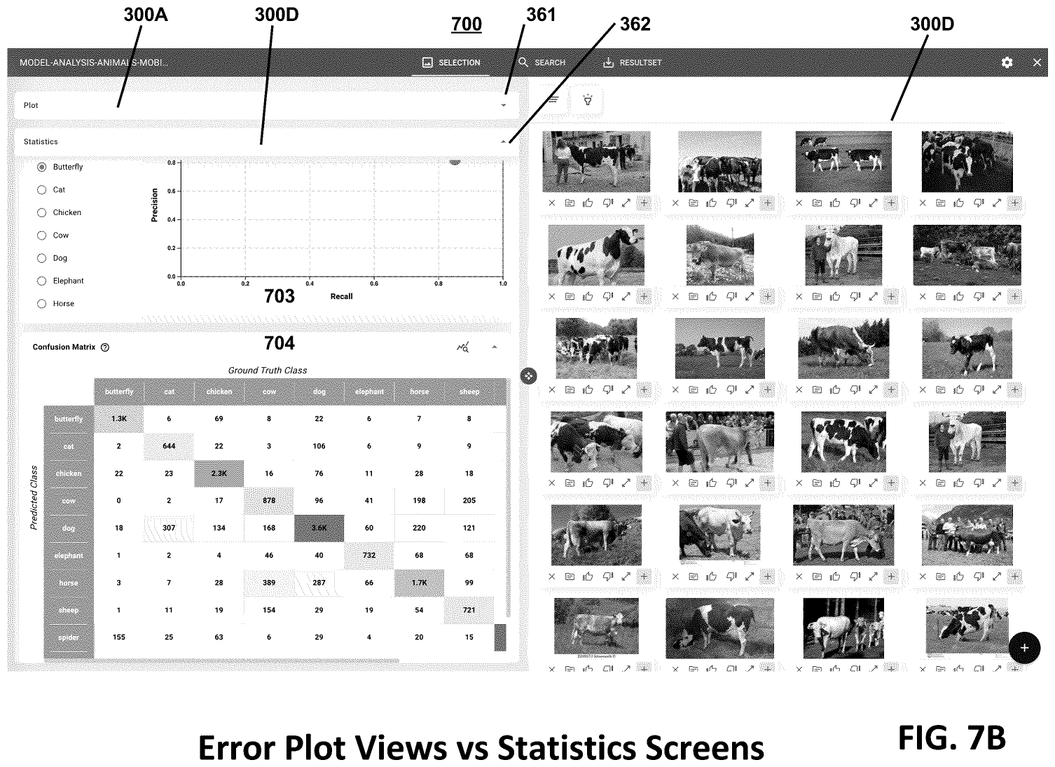

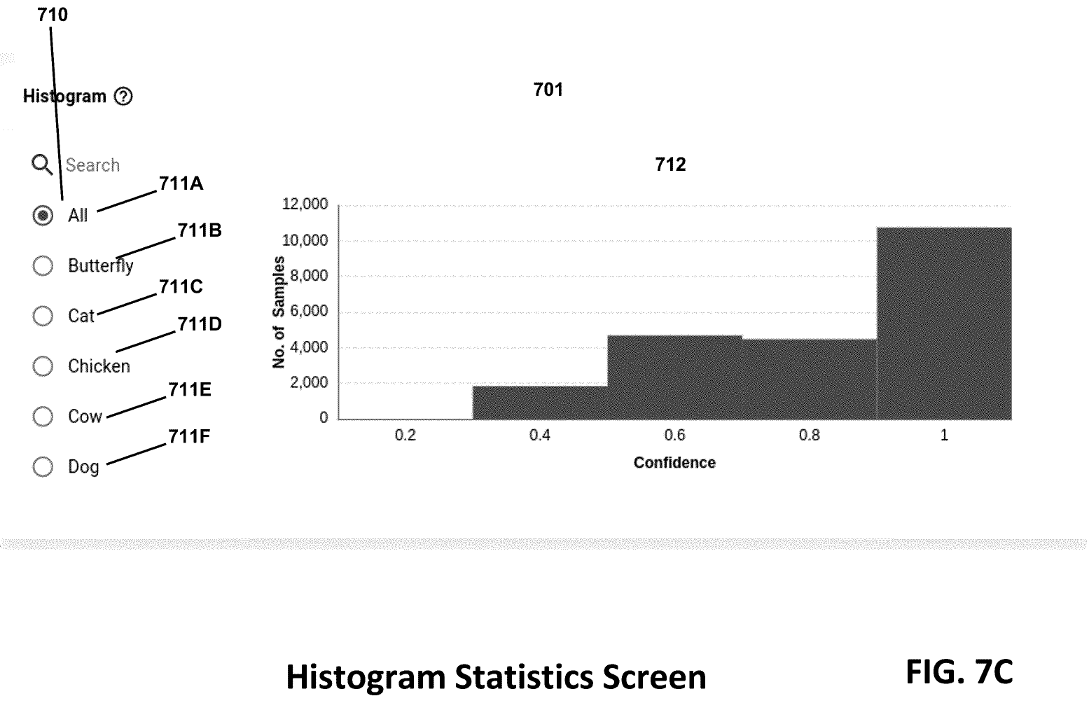

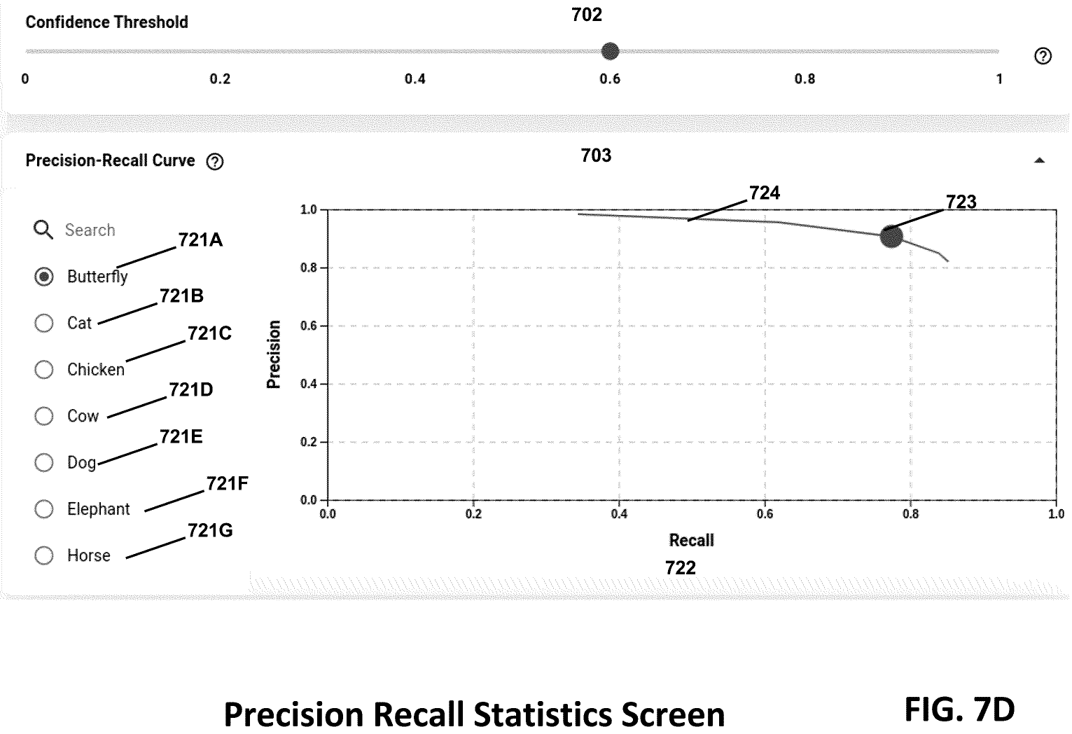

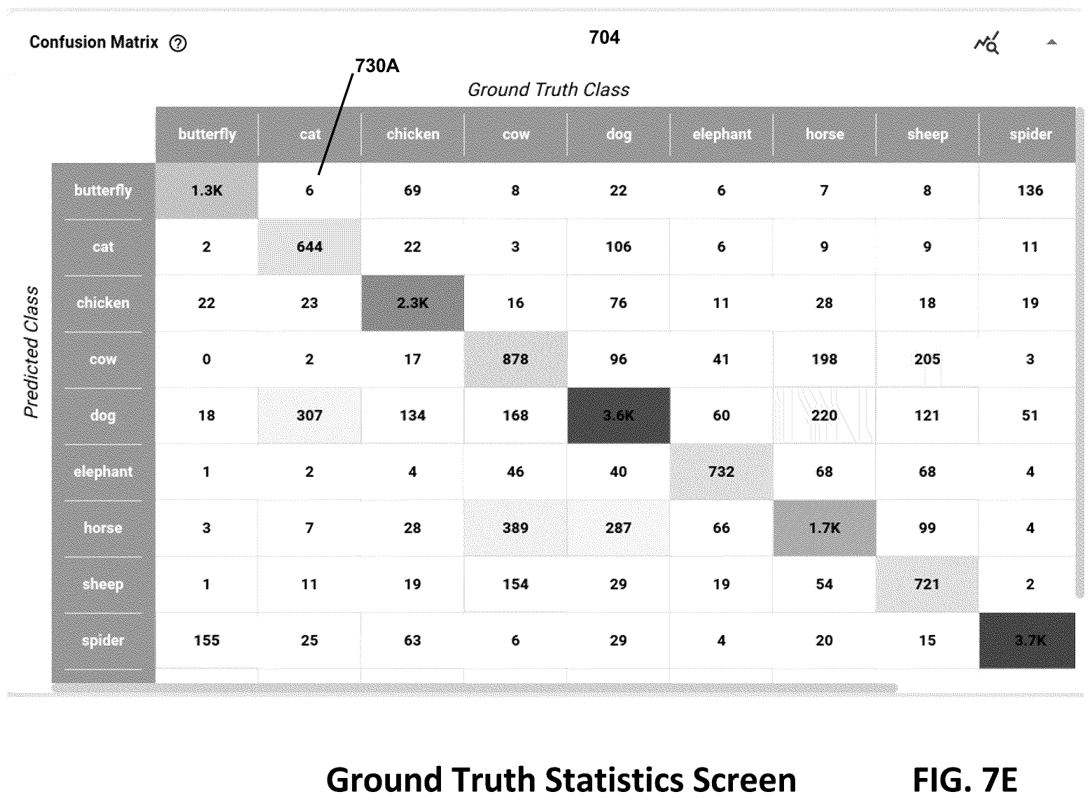

The image processing system 102 can read digital images stored in a database 101 that is stored in a storage device 124 of the system. The database 101 often contains metadata associated with the digital images that can be useful in image analysis. In another embodiment the database 101 is stored in another storage device (e.g., memory 720, SSD 730, Disk Drive 740 shown in FIG. 7) separate from the storage device 124. In other cases, the database 101 and the storage device 124 can be remote and processed by one or more remote processors with software and utilized by clients having sufficient hardware and storage.

The machine learning (AI) model 104 can be trained to recognize one or more classes and/or one or more objects within the digital images. In one embodiment, the machine learning (AI) model 104 is used with one or more classifier algorithms to label and classify the images and identify objects therein.

Once the image data is processed by the image processing system 102, the image data can be used to train an AI model 104 in a training mode 105A. The AI model 104 can be validated with additional image data that is excluded from the training process. If the AI model 104 has been previously trained (pretrained), it can be used in an inference mode 105B to detect objects in the digital images.

A user can interact with the system 100 through the user interface 106. The user interface 106 can be used to build one or more AI models for a new sample of images and new objects. The user interface 106 can be used to seed the recognition/classification of one or more objects in the new sample of images. The user interface 106 can receive a report generated by the use of the AI model 104 and algorithms in analyzing new digital images and objects therein The report and inferences can be viewed in various windows generated by the user interface 106 on a display device.

### Objects of the Disclosed Embodiments

The disclosed embodiments use machine learning to provide a coherent visualization of an image classification model's performance in terms of the frequency and magnitude of prediction failures over a test dataset.

The disclosed embodiments help practitioners identify and rank critical failure modes of an ML model, and consequently guide deployment decisions and subsequent model improvement efforts.

The disclosed embodiments act on model predictions along with ground truth labels to compute an error-based feature representation of each sample in the test dataset.

The disclosed embodiments use machine learning to reduce the above feature representations to coherent 2-dimensional scatter-plot visualizations that simplify risk assessments of the ML model.

The disclosed embodiments provide a user interface to display the underlying data alongside the 2-dimensional scatterplot, which allow practitioners to identify patterns in the data that cause model failures.

Using the proposed ML-based approach to identify patterns in failure modes allows practitioners to target data curation, labeling, and model training efforts on the most critical failure modes. At worst, this leads to significant cost savings and time savings in data labeling and model training; the time savings can produce further downstream benefits by making practitioners more engaged and productive. At best, this can fix critical model failure modes that may hitherto be impossible to address without the targeted training; this can make or break an AI-based business.

### Computer Vision Models: Image Classification

The image classification problem in computer vision involves assigning one out of a specified set of object classes to each input (query) image; assigning confidence scores to all of the classes is also common. Variants of the problem include binary classification, multiclass classification, multilabel classification, etc. Image classification features prominently in applications such as driving, counting, activity recognition, and is usually the first step in others such as face recognition, object tracking, etc.

Common image classification models are convolutional neural network (CNN) based models, including variants of ResNet, MobileNet, EfficientNet, Inception, etc. Recently, transformer-based architectures such as ViT (Vision Transformer) have also gained traction as an image classification model. Deep learning platforms, such as TensorFlow and PyTorch, provide tools for easy setup and training of these image classification models, as well as a collection of pre-trained models to get started with transfer learning.

These machine learning (ML) models are trained under supervision (e.g., manual labeling of objects) using a large set of images, along with a class label for each image that serves as the supervision target. The quality of an image classification model is directly dependent on the amount and distribution of the training dataset. Having a large set of diverse examples for a particular object class during training allows the ML model to make good predictions for that object class during subsequent inference.

Another common problem in computer vision is that of object detection. In this problem, the goal is to identify one or multiple instances of one or multiple classes in a given image, along with the locations of said instances in the image. While the primary embodiment in this patent application relates to image classification, commentary on adapting this method to an embodiment related to object detection is also presented.

### Iterative Model Refinement

In training of machine learning models, they are usually not trained once and then deployed. An iterative model refinement (training or learning) process is typically standard practice. The ML models are often trained multiple times on different image sets before being deployed for operational use by users.

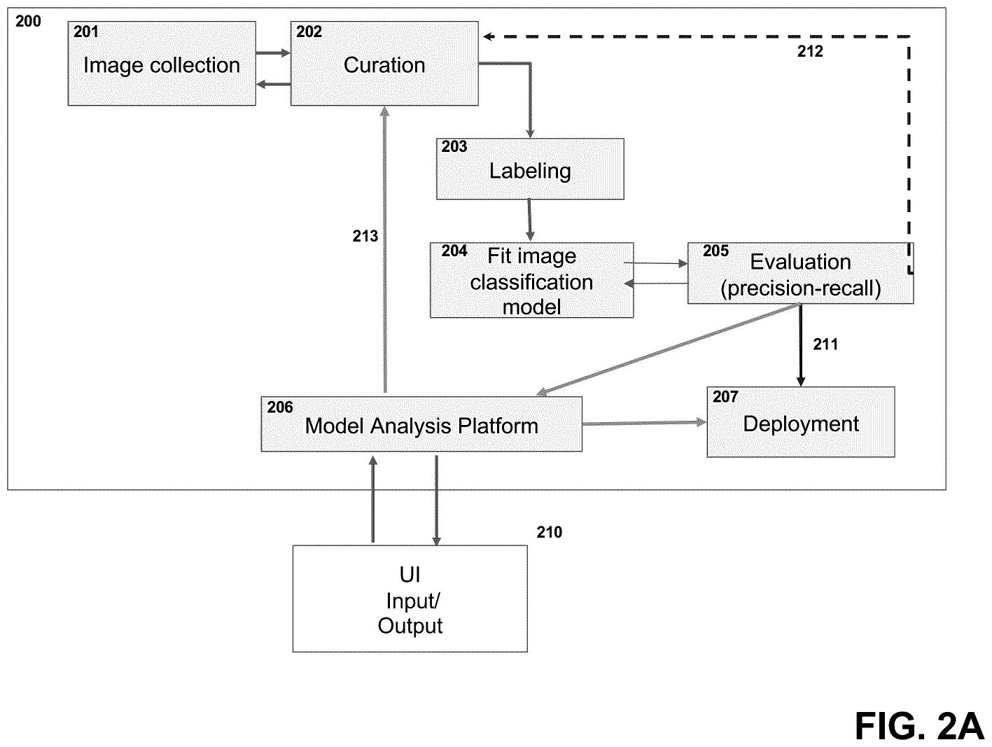

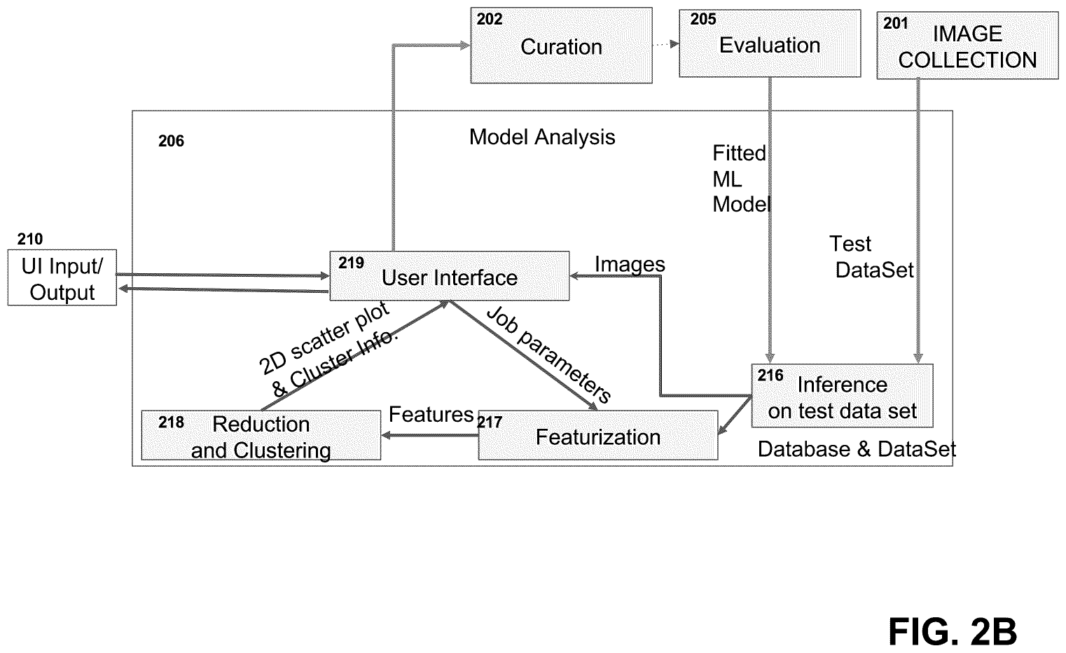

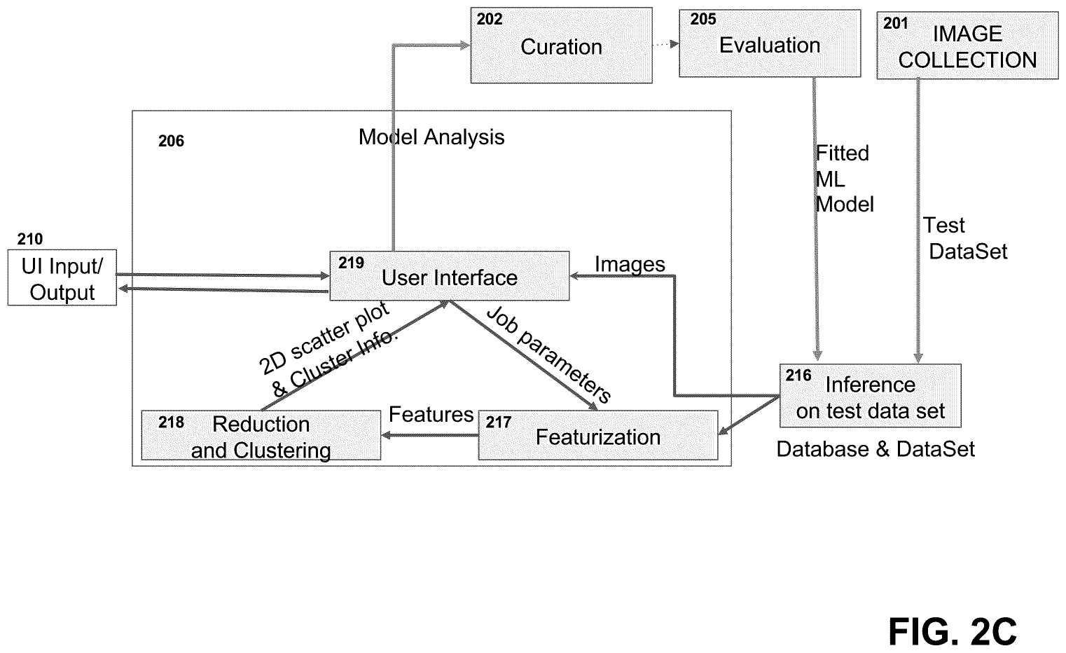

FIG. 2A represents an embodiment of the iterative ML model refinement process 200. The iterative ML model refinement process 200 uses a model analysis process 206 provided by a model analysis platform to improve the ML model. The ML model can be used for image classification and/or object identification. The iterative model refinement process 200 has an interactive user interface (UI) 210 to accept user inputs by way of an input device from ML model experts and other humans to support the various processes. The UI 210 can also include an output device such as a display device or a printout device, to display a user interface for a user to interact with the processes or provide feedback to the user, such as evaluation scores of an ML model. The iterative model refinement process 200 is initialized by an image collection process 201.

In the image collection process 201, ML practitioners acquire a large amount of raw and unlabeled images and store them in a database as an image dataset. The image dataset often contains metadata in addition to the raw images, where the metadata can support coarse identification and filtering of the underlying image data samples. Subsequent stages of the model refinement process select smaller subsets of this large initial dataset. When the acquired dataset is not sufficient in size or diversity, the image collection process can continue with additional rounds of data acquisition of digital images. The process 200 then goes to an iterative data curation process 202.

In the data curation process 202, smaller subsets of the acquired image dataset are selected. The subsets have fewer digital images than that of the overall acquired image dataset. In the initial iterations of iterative data curation process 202, the selection of images can be performed randomly with a random sampling process. Later iterations of the iterative data curation process 202 can use heuristics based on metadata or other image-features. The goal of the iterative data curation process 202 is to provide the most relevant training sets of image data (curated images) that are likely to address failure modes in the ML model. The process 200 then goes to a labeling process 203.

In the labeling process 203, the curated images are labeled by human experts, usually using a labeling platform. The labeling platform itself can use a weaker image classification model than that of the ML model to propose initial labels (priors), which can then be subsequently approved, edited, or discarded by the human expert to provide the final label. The process 200 then goes to a fitting process 204 of the image classification model.

The labeled images are then used in a fitting process 204 to incrementally fit the labeled images to the ML model, such as an image classification model. The process can then go to an evaluation process 205.

In the evaluation process 205, with a different set of images than were used for training, the fit of the image classification model is evaluated. The fit of the image classification model is usually evaluated in terms of the precision, recall, and/or accuracy over each class, aggregated over all classes, or some weighted average of per-class-metrics. In in the case of an image classification model, a class-wise evaluation of divergence between ground truth class-labels and model prediction confidences can be performed. In the case of an object detection model, a class wise evaluation and a region wise evaluation can both be performed. A region-wise evaluation of divergence between ground truth object bounding boxes and model prediction bounding boxes can be performed.

The evaluation process 205 can trigger a stopping condition for the model fitting process. Evaluation scores of the ML model are compared with specified model requirements or criterion to determine if fitted ML model is acceptable (positive-above specifications) or unacceptable (negative-below specifications).

In a conventional flow of machine learning model development, if after the fitting is complete the evaluation looks positive, then the new model can be deployed in a deployment process 207 as indicated by line 211.

After each step of the fitting process 204, the evaluation process 205 is run over some validation data to decide if the fitting over the current training set is optimal. If after the fitting is complete, the evaluation scores do not meet specified requirements or criterion, another iteration of the full training cycle (curation/collection to labeling to fitting) is triggered. With these negative results, the conventional flow of new model development skips a model analysis process 206 and returns to the curation process 202 as indicated by a dashed line 212.

However, the process 200 is not conventional in that it further includes a model analysis process 206 with a model analysis platform. The evaluation scores in the evaluation process 205 often do not provide sufficient insight into the terms or conditions that cause model failures. This lack of insight can make subsequent training iterations ineffective, or even counterproductive in some rare cases. If the evaluation scores in evaluation process 205 are poor, then the model analysis process 206 can explain the poor scores and guide subsequent model refinement. If the evaluation scores are good, then the model analysis process 206 provides a more rigorous check of model quality before the model is deployed.

The model analysis process 206 by the model analysis platform 206 provides a clean visual representation of model prediction failures to the ML practitioner, thus providing failing insight and model failure modes (failure modes of the ML model). After the model analysis process 206 with the model analysis platform 206 generates the failing insights and failure modes of the ML model, the process 200 returns to the curation process 202 as indicated by arrow 213 to start another training iteration of the ML model on a new training set.

A next iteration of the training process (curation 202, labeling 203, fitting 204, and evaluation 205) incorporates the failing insights and failure modes generated using the model analysis process 206 into data curation 202. The data curation process 202 targets the one or more failure modes of the ML model under development. The failing insights and failure modes can trigger another round of data collection with the image collection process 201 if the required image data to target the failure modes isn't already available in the current dataset stored in the database. Following data curation process 202 selecting training subsets targeting the failing insights and failure modes, the next training iteration further includes the labeling (annotation) process 203, the model fitting process 204, the evaluation process 205, and another round of the model analysis process 206.

In the case of object detection, the overall workflow remains the same, with changes only occurring within some of the processes. The labeling process 203 assigns one or multiple object labels and bounding boxes to each image, instead of class-wise confidence scores. The model fitting process 204 fits an object detection model, which usually requires more computational resources than an image classification model during fitting. The evaluation process 205 evaluates the object detection model produced by model fitting process 204 and is similarly more computationally expensive compared to the image classification case.

### Model Analysis User Interface

Referring now to FIG. 2B, the model analysis process 206 is performed by a model analysis software platform provided by a plurality of software modules including, an inference module 216, a featurization module 217, a reduction and clustering module 217, and a user interface module 219. One or more of the plurality of software modules interfaces with other software modules and hardware that performs the model generation processes of FIG. 2B. For example, the user interface module 219 interfaces to user interface I/O devices 210 and the curation process 202. The inference module 216 interfaces with the evaluation process 205 and the image collection process 201.

The user interface module 219 allows user interaction through the UI devices 210. The user interface module 219 provides a visualization on a display device of a model's prediction performance on a test dataset. The user interface module 219 can generate various user interface windows that can be displayed to show the module failure modes and provide failure insight to a user.

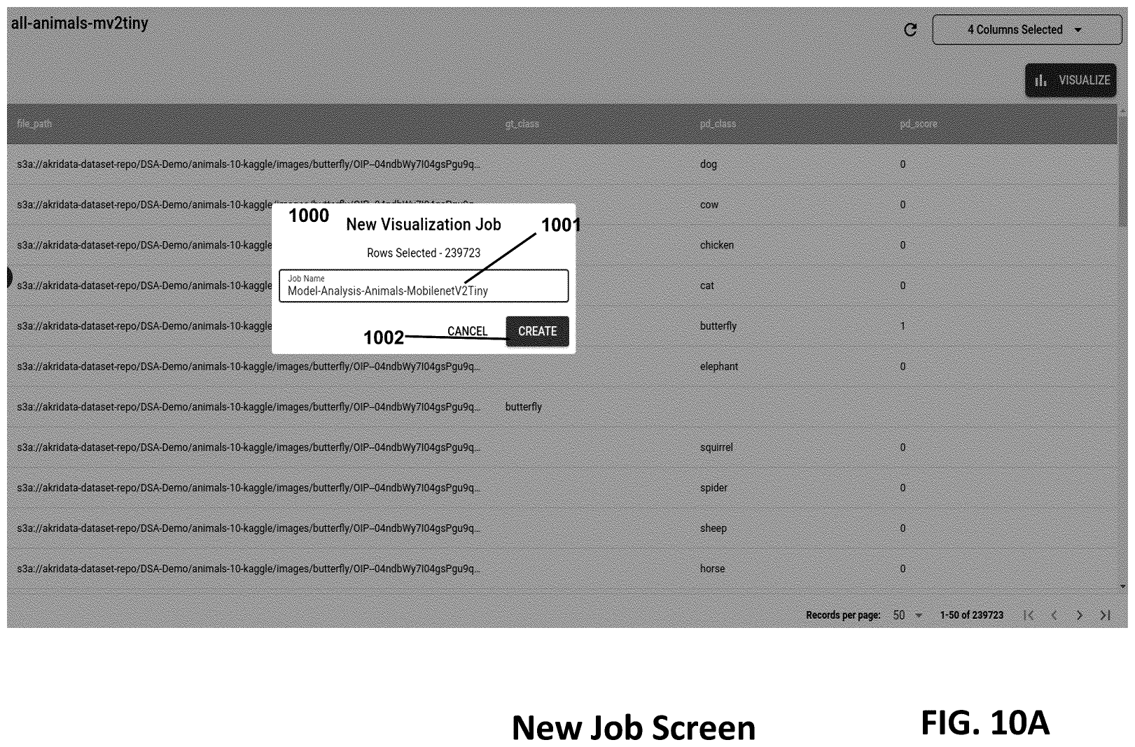

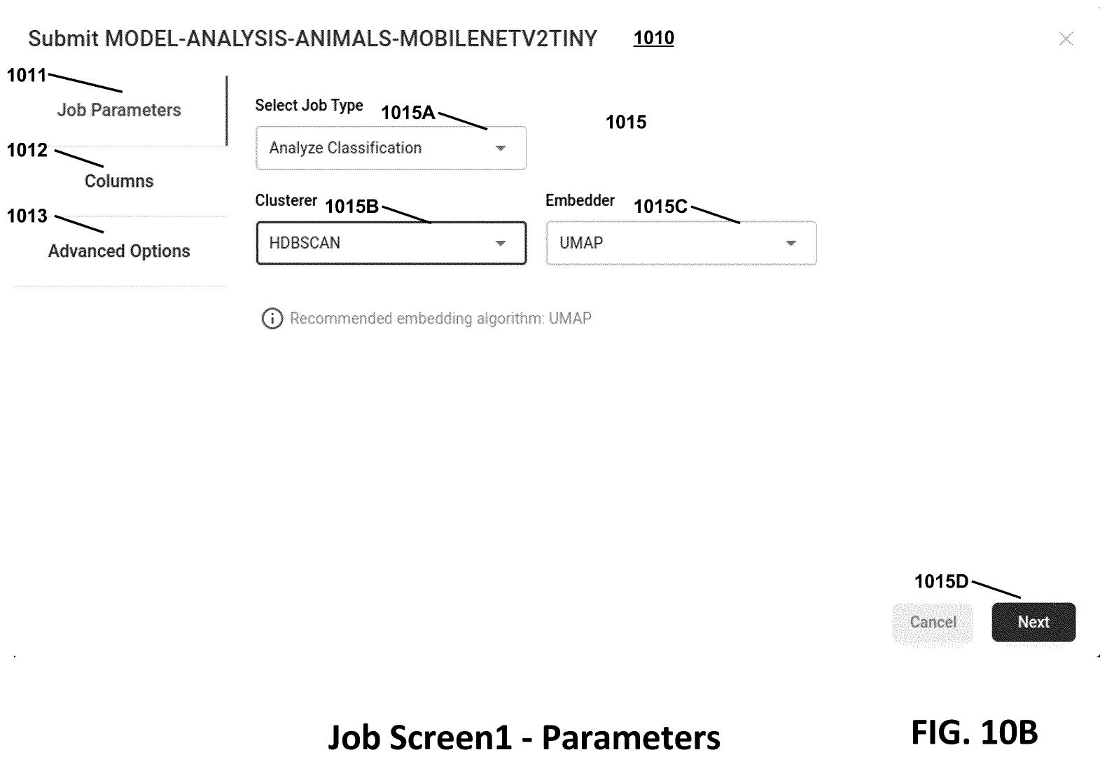

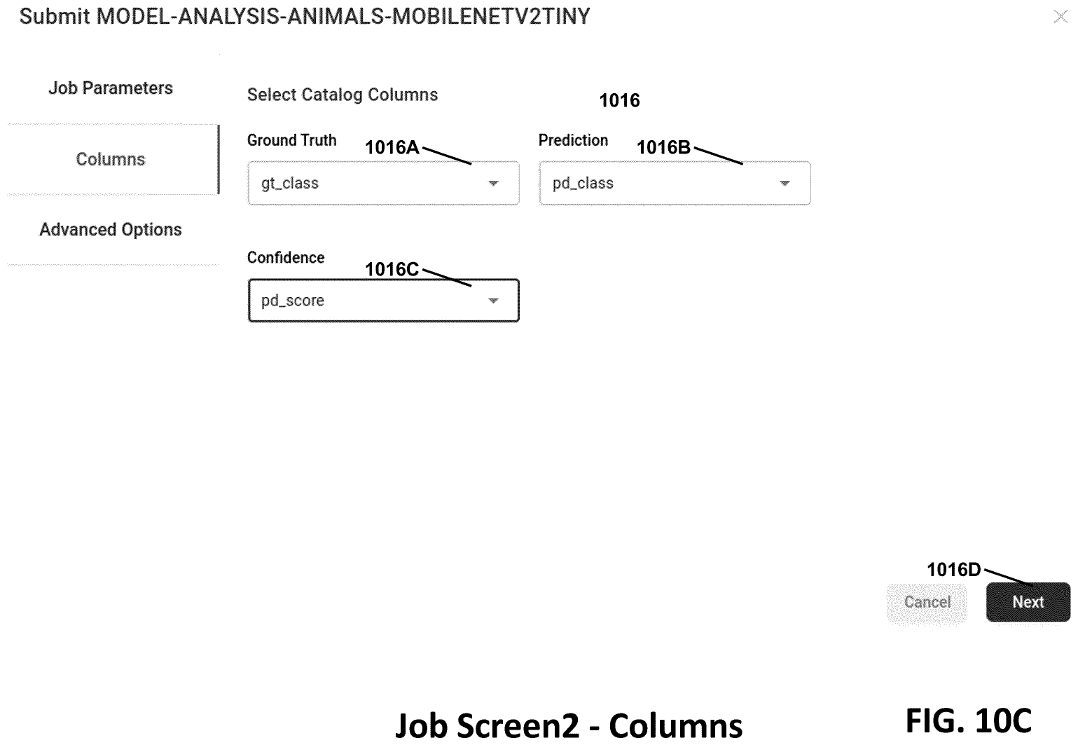

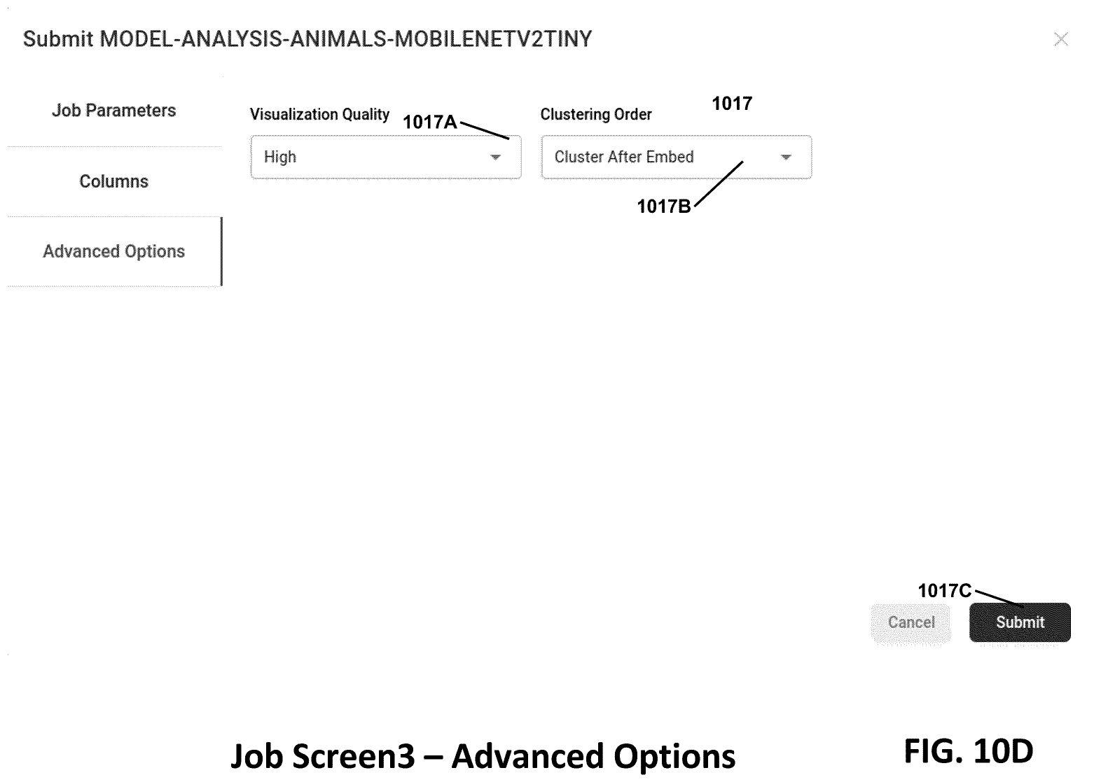

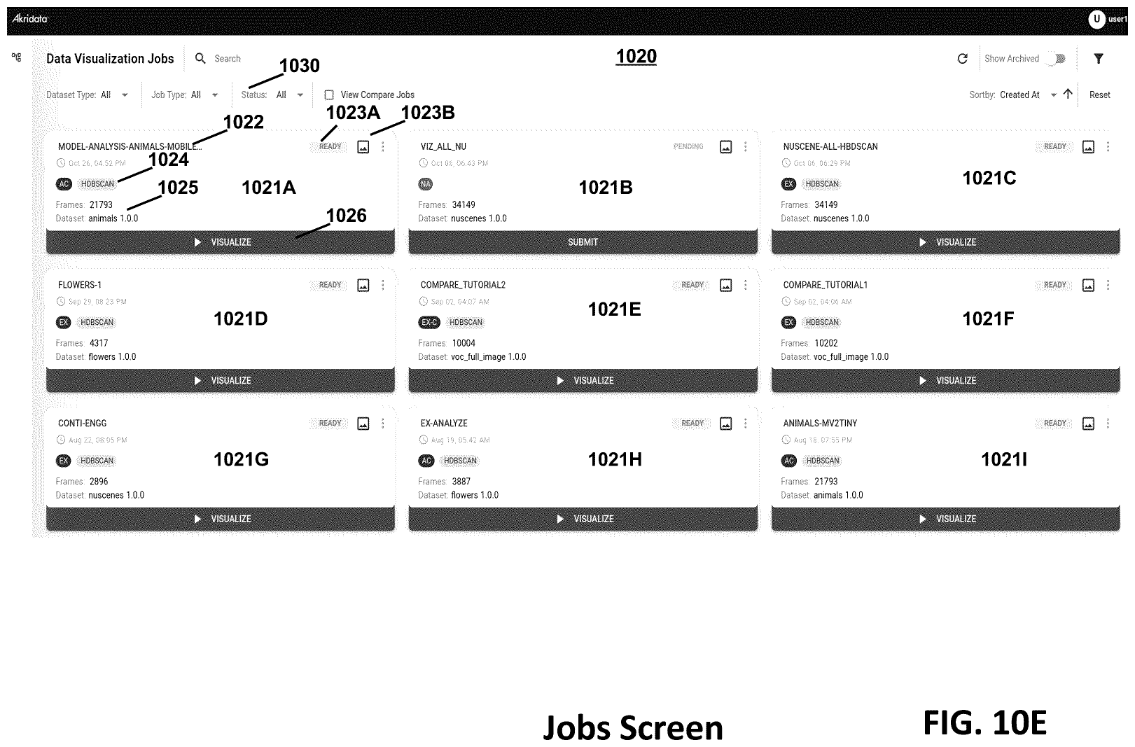

FIG. 2C provides an alternative implementation of the model analysis process 206, where the inference process 216 happens outside the model analysis platform. This is preferred for cases where the ML model is proprietary, or the computational infrastructure necessary for inference is not easily exposed to workflows such as the current one. In such cases, only the test dataset and associated machine learning labels are supplied to the model analysis platform. The detailed workflow to provide the test dataset and associated labels and submitting a model analysis visualization job is illustrated in FIGS. 10, 11, and 12. The user interface after job submission is first discussed below.

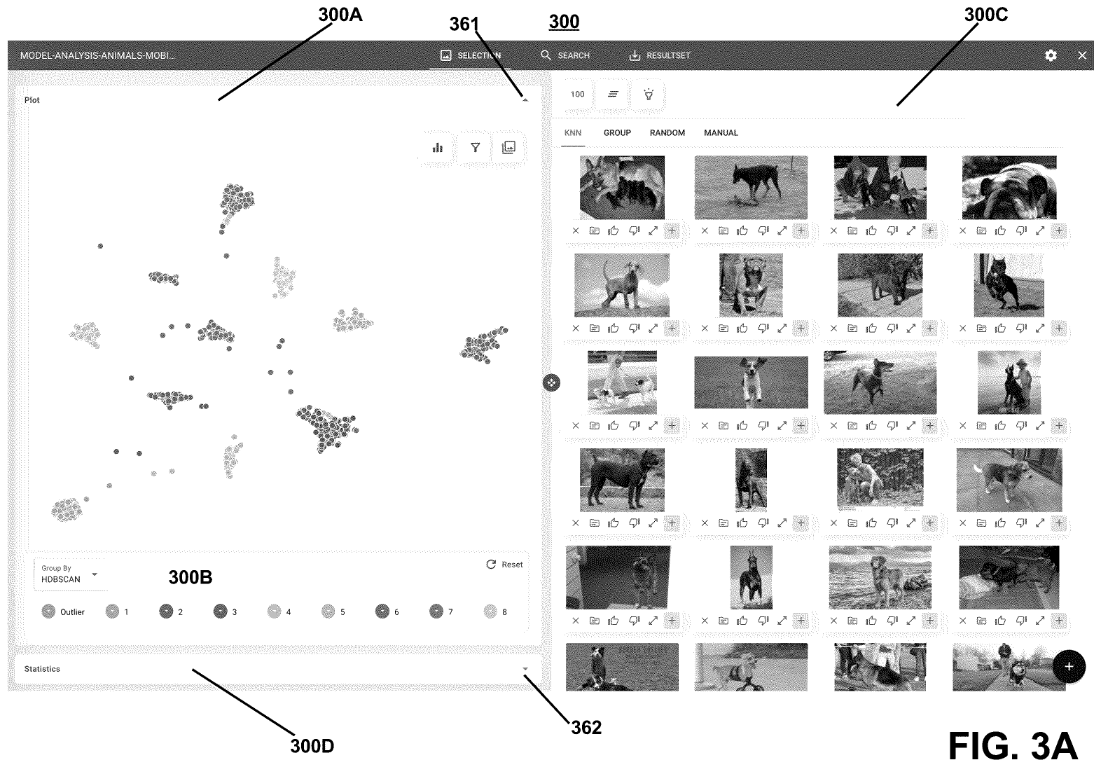

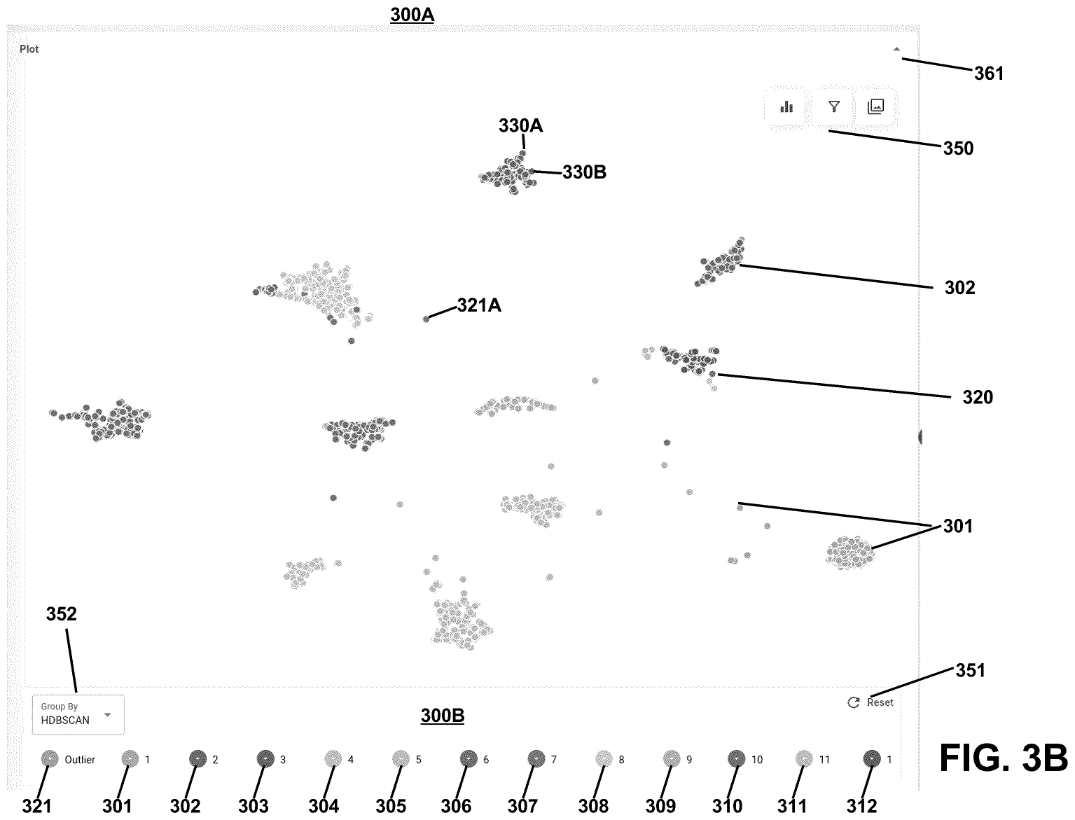

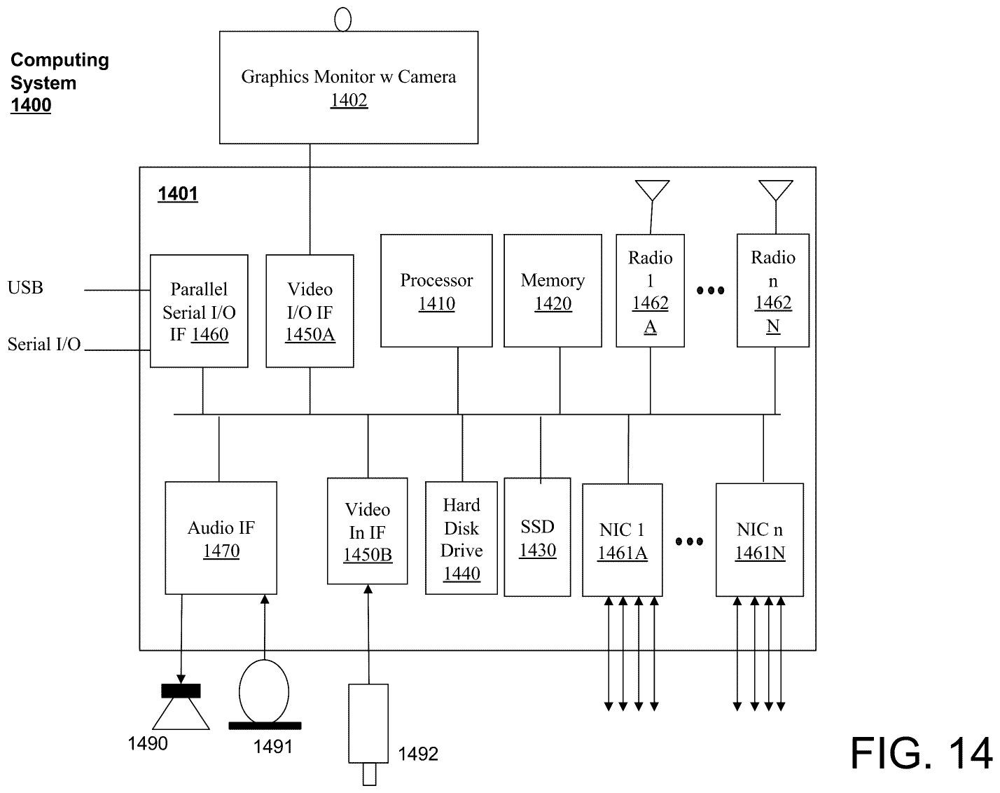

FIG. 3A shows an interactive user interface window 300 generated by the interactive UI module 219 displayed on a display device (e.g., see display device 1402 shown in FIG. 14). The interactive user interface window 300 allows a user to visualize and analyze the ML model performance.

The UI window 300 includes a two-dimensional color scatter-plot window 300A and an inset (overlaid) legend window 300B. The scatter-plot window 300A shows a reduced feature representation of prediction errors made by the ML model with data samples. The scatter plot window shows an aggregate view of a plurality of data points associated with images forming a scatter plot. The scatter-plot window 300A also shows clusters formed by the data samples based on prediction errors. The scatter-plot window can alternatively be referred to as a plot-view or error-view.

The UI window 300 also includes a data view window 300C and a statistics view window 300D, which is shown as a collapsed window in FIG. 3A. The data view window 300C shows the images, and optionally metadata, for data points selected from the scatter plot window 300A or the statistics view window 300D. The arrow buttons 361 and 362 control which of the UI windows, scatter plot window 300A or statistics view window 300D, are collapsed. The scatter plot window can include a plurality of option buttons to filter, sample, and view images corresponding to the data points in the scatter plot. The scatter plot window can provide an inset window with a legend and interactive buttons to control the scatter plot of the data points.

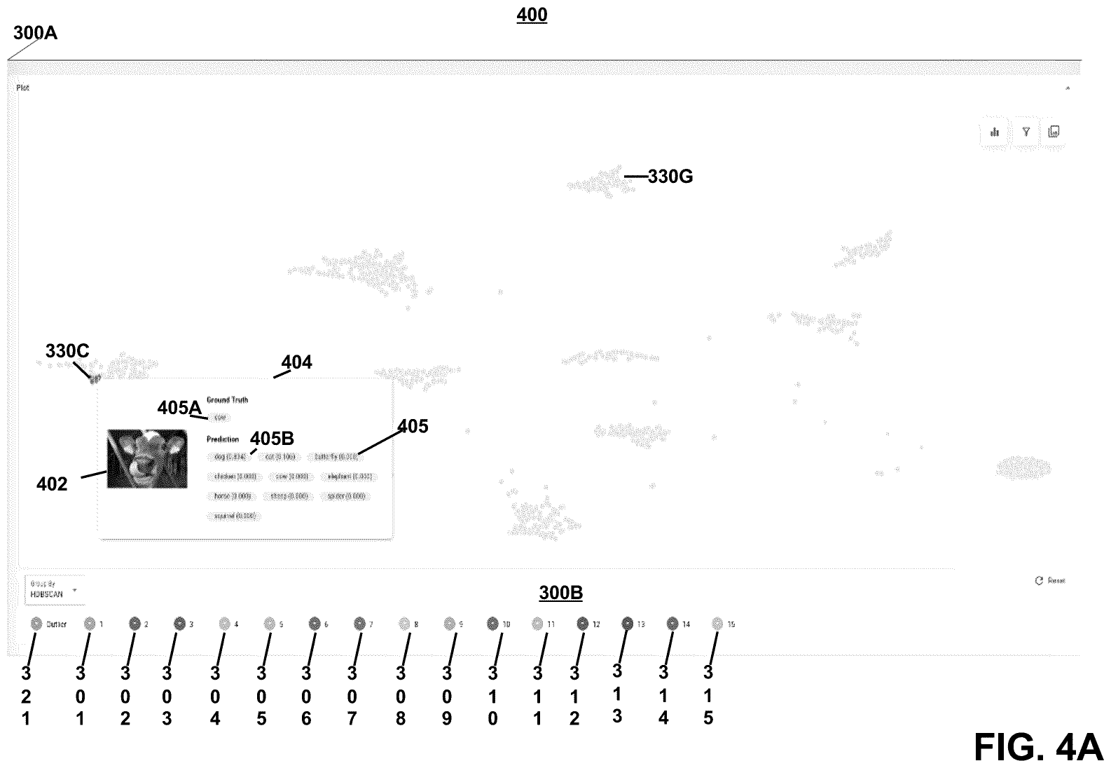

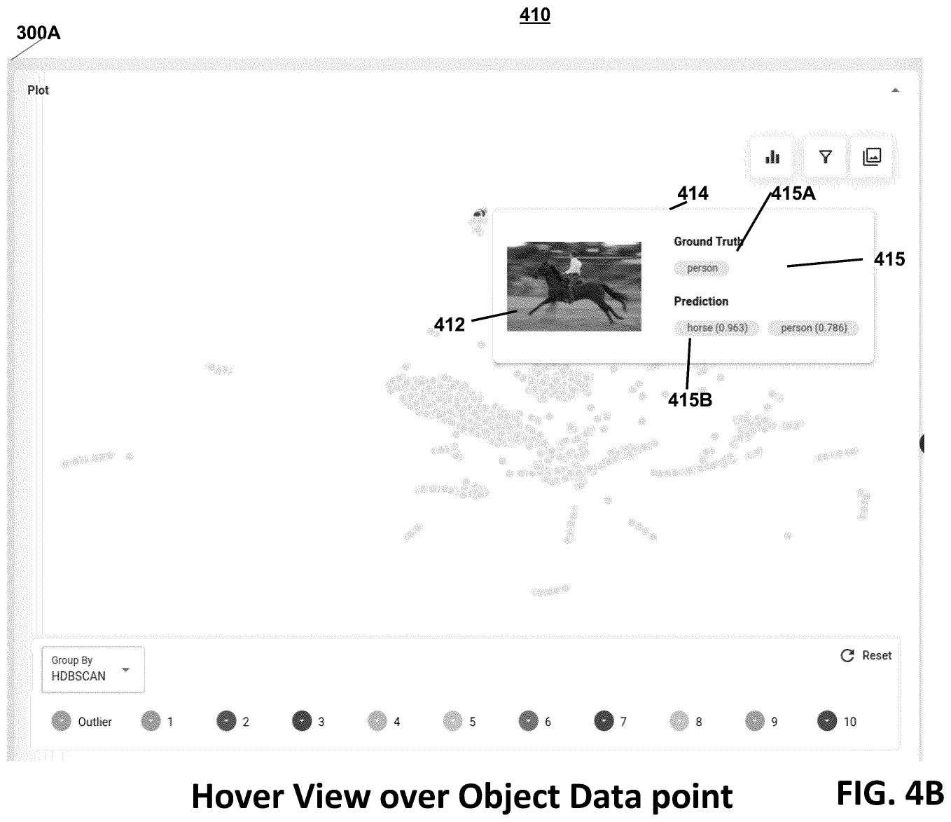

FIG. 3B provides a detailed view of the scatter plot window 300A and the associated inset legend window 300B. The data points 320 in the color scatter plot window 300A illustrates the prediction errors produced by the image classification model under test. The color scatter plot window 300A includes coloring (color coding generated by the UI module 219 and numbering) of data points by the various clusters 301-315 (see FIG. 4A) of the prediction errors produced by the image classification model under test. For example, the data points 320 in cluster one 301 are all colored lime green. The data points 320 in cluster two 302 are all colored purple. Data points 320 that are outliers 321 without any cluster can be represented by a grey color.

A cluster with a plurality of data points can be selected for splitting it up into subclusters. For example, cluster one 301 can be chosen and it can be split into two or more subclusters of each having a plurality of data points separated out from the cluster one. This can be advantageous when there is only one cluster that is too large to analyze all at once. Similarly, a cluster with a plurality of data points can be select for a merger operation of its data points into another cluster (a parent cluster). For example, cluster one 301 can be chosen and it can be merged into cluster two 302, a parent cluster, with all data points merged together under the parent cluster.

Data points in the scatter plot 300A that are close to each other, such as data points 330A and 330B, represent data samples (images) with similar prediction errors. An outlying data point, such as data point 321A, has a unique prediction error.

The UI module 219 generates one or more control icons 350 in the UI window that can be selected to change the scatter plot 300A. The UI module 219 further generates a reset button 351 in the legend window 300B that can be selected by a user to refresh the scatter plot. The UI module 219 further generates a pull-down menu 351 in the legend window 300B for selecting how the data points are grouped together in clusters. An ‘up arrow’ 361 is also provided to collapse the entire scatter plot window 300A and display other windows in the UI window 300.

Referring now to FIG. 4A, the UI module 219 can generate another UI window 400 that allows the user to identify a model failure mode responsible for a given point in the color scatter plot 300A. A user can select (by hovering over) a data point in the color scatter plot 300A to inquire of its failure mode. The user selects the data point by hovering a UI input device, such as a mouse pointer, over the data point in the scatter plot window 300B. When hovering over a data point, the UI module generates the UI window 400 with a grey scale scatter plot window 400A and the inset legend window 300B. Hovering on the data point displays the associated image, as well as the true label and model-predicted labels.

In the grey scale scatter plot window 400A, the data point 330C is highlighted in bold black, while other data points 330G are grayed out into a light shade of grey. Furthermore, the underlying image 402 and labels 405 associated with the data point 330C are displayed in an inset window 404 adjacent to the hovered data point 330C. For example, in the case of the hovered datapoint 330C, the model failure is associated with the prediction having a high confidence for one class, a ‘dog’ class 405B, whereas the true label (Ground Truth) for the image is for another class, a ‘cow’ class 405A.

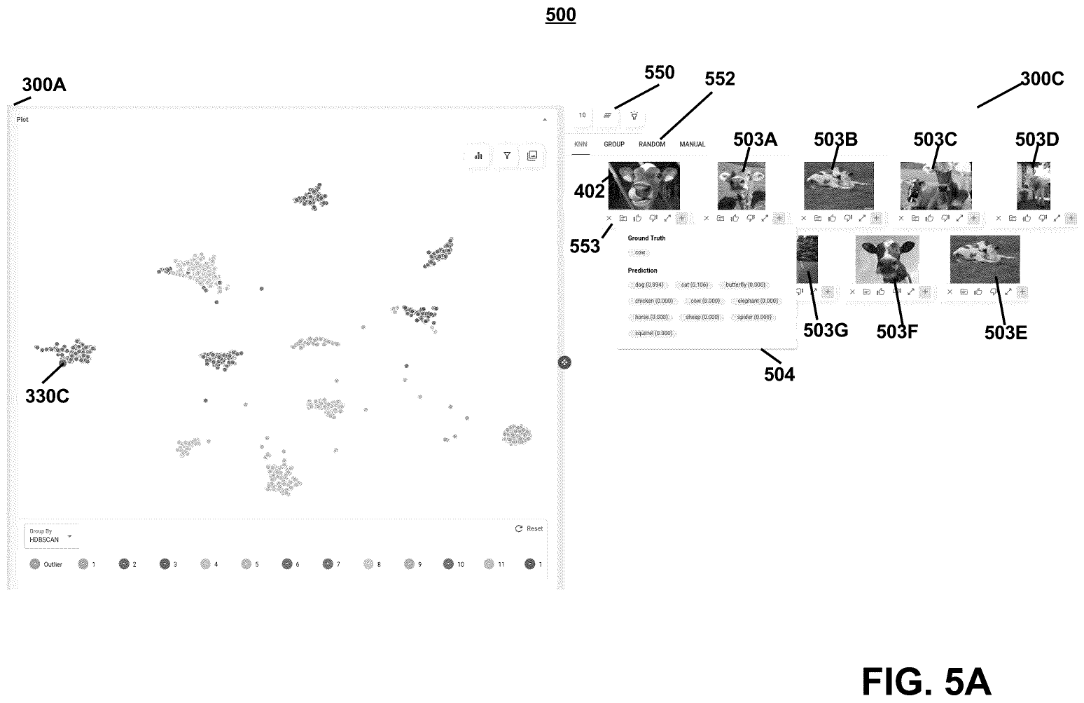

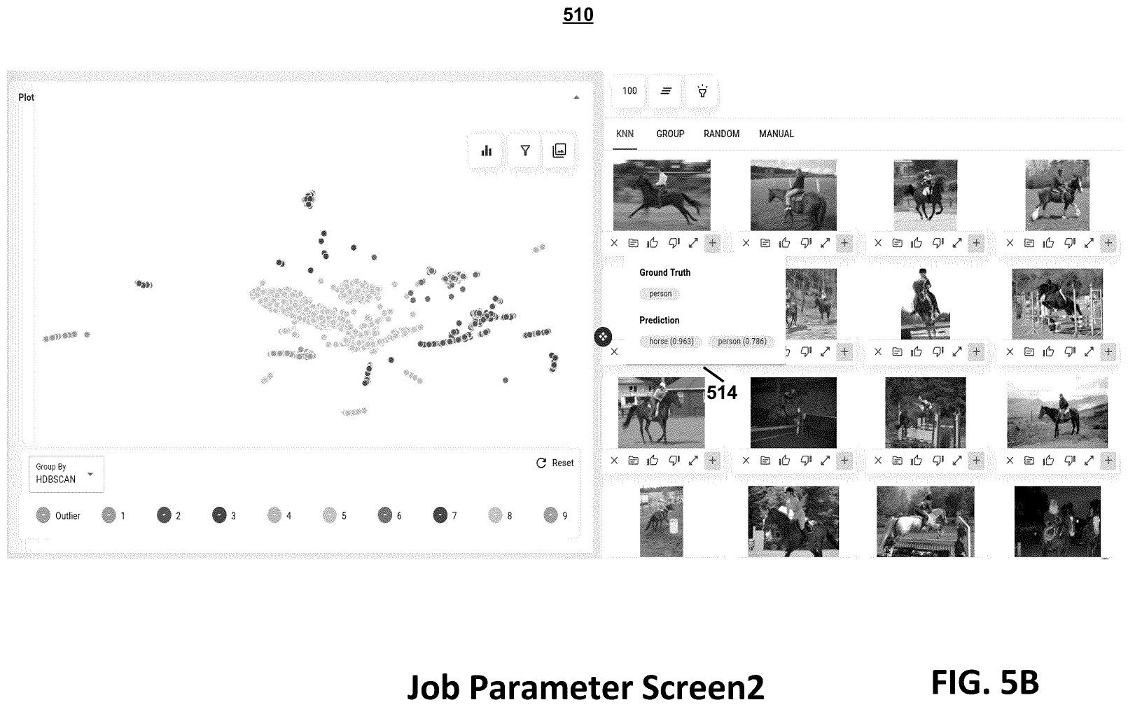

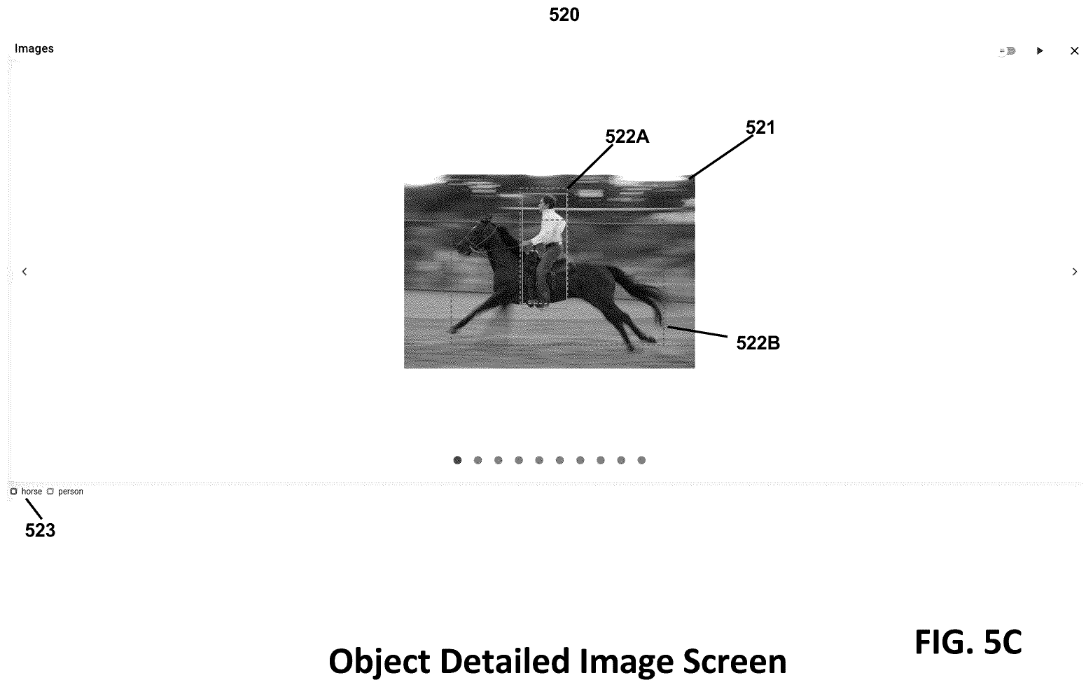

Referring now to FIG. 5A, the UI module 219 can further generate a UI window 500 that allows the user to visualize a plurality of underlying images corresponding to a selected data point and depending upon the mode selected, nearby data points (touching or within a predetermined radius of a selected data point) in a cluster displayed in the scatter plot. In this manner, insight into the failure mode for a group of nearby points can be discovered. The selection of nearby data points in a cluster is triggered by the user clicking on a data point of interest with an input device, such as a mouse, instead of just hovering over the data point. Assume the hovered over data point 330C in FIG. 4A is also now the selected point 330C in FIG. 5A. In addition to the plot view or scatter plot window, clicking on a data point displays the image for the associated data point. Depending upon a mode selected, the associated images for nearby data points may also be displayed. The underlying images are displayed in a Data view window 300C. For each individual image, the associated true and predicted labels can be displayed and viewable to a user by hovering the UI input device over the respective image.

In the UI window 500 shown in FIG. 5A, a scatter plot window 300A is displayed side by side with a data view window 300C. The data view window 300C shows a plurality of images 502A-520G for the nearby data points, including the image 402 of the selected data point 330C, previously the hovered data point 330C in the UI window 300A shown in FIG. 4A. The data view window 300C allows the user to probe the labels associated with each individual image. The user can hover a mouse over an image and an inset window 504 is generated which shows the labels associated with the chosen image. In this case, the inset window 504 corresponds to the selected (clicked) data point 330C and its underlying image 402. In the case shown in FIG. 5A, all nearby data points around the clicked data point 330C correspond to images 503A-503E of cows, which are incorrectly predicted by the ML model as being images of dogs. The clicked data point 330C also corresponds to an image 402 of a cow which was incorrectly predicted by the ML model as being an image of a dog. Accordingly, the clicked data point and the nearby data points in a cluster can have the same model failure mode.

The data view window 300C of the UI window 500 that is generated by the UI module, includes one or more selectable icons 550; the editable number field allows the user to specify the number of samples to populate in the data view; the horizontal bars icon allows the user to clear the selected samples in the data view, thus allowing the user to start a fresh investigation over a different selection of data samples; the torch icon allows the user to highlight the corresponding points in the scatter plot window. The data view window 300C further includes one or more menu buttons 552 that can be selected, such as KNN, GROUP, RANDOM, and MANUAL. The one or more menu items 552 can select the mode by which data points are selected, such as nearest neighbor, grouped within a selected cluster, random across the scatter plot, or manually selected by the user.

Furthermore, in the data view window 300C, there is a frame around each image 402, 503A-503G that is generated by the UI module. The frame for each image includes a plurality of user interface control icons 553, such as a close icon (a small x icon), a file folder icon, a thumbs-up icon, a thumbs-down icon, a window expansion icon (a double headed arrow) and an add image icon (a plus icon). Selection of the close icon removes the image from the data view window. Selection of the file folder icon brings up an inset window (see inset window 514 shown in FIG. 5B) with information about the image. Selection of the thumbs-up icon marks a sample as being of interest and saves the image for any subsequent investigations. Selection of the thumbs-down icon marks a sample as being uninteresting for the user's investigations. Selection of the window expansion icon brings up a large size high resolution image that can be examined in greater detail by the user (e.g., See FIG. 5C). The window expansion icon (a double headed arrow) changes to the window contraction icon (a large X icon) in the frame around the high-resolution image that can be selected to close it down to the smaller size lower resolution image shown in FIG. 5A. Selection of the add image icon adds the associated image to the curated data set as part of the curation process 202 shown in FIG. 2C.

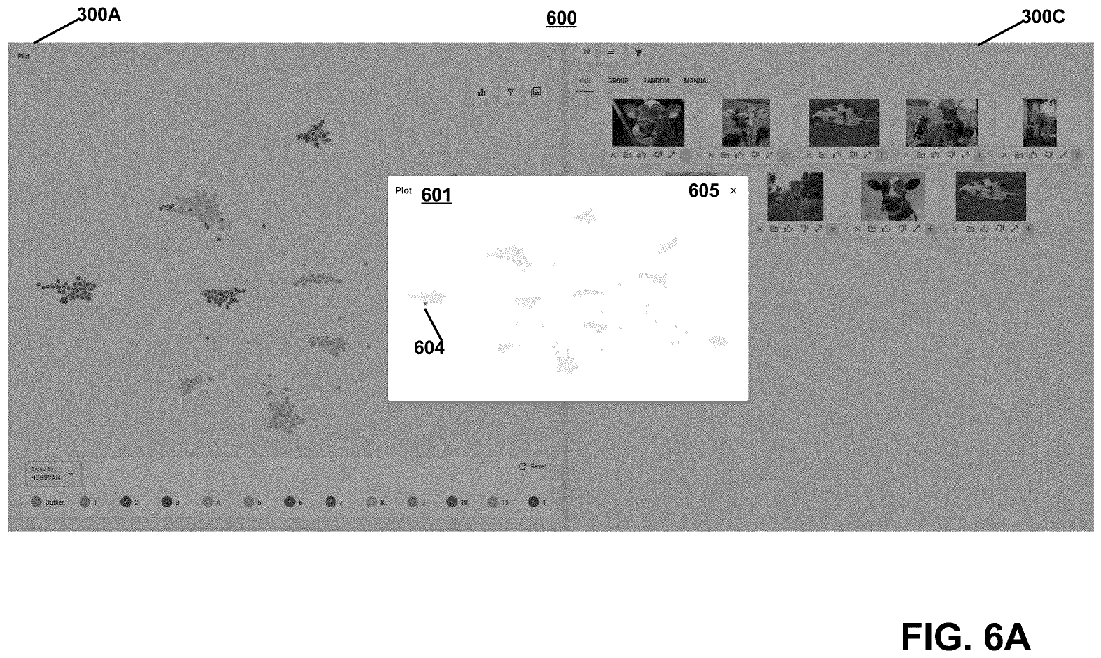

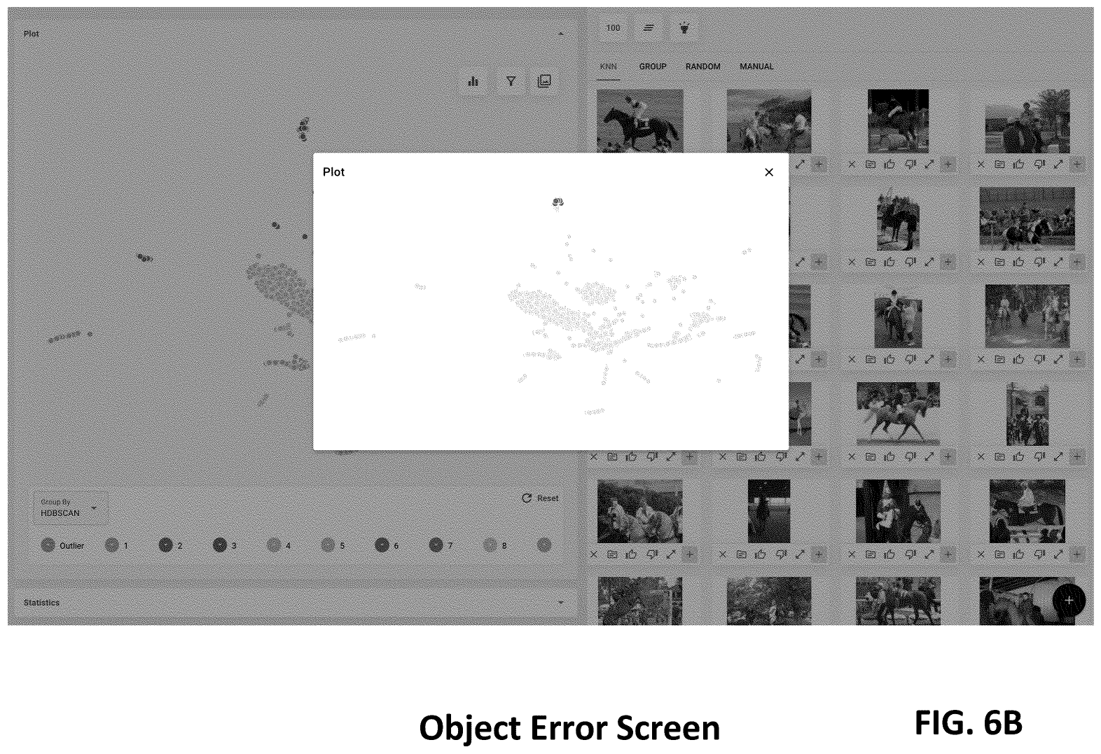

Referring now to FIG. 6A, the UI module further allows the user to highlight the data points in the scatter plot whose underlying images are currently displayed in the data view window 300C. In the UI window 600 shown in FIG. 6A, the UI module can further generate an overlaid plot window 601 that it overlays onto the scatter plot window 300A and the data view window 300C shown in FIG. 5A. The generation of the plot window 601 can be selected by clicking on the torch icon in the icon menu bar 550.

The overlaid plot window 601 shows the selected and nearby data points 604 in a black bold color while all other data points are grayed out. A close X icon 605 is selectable in the upper righthand corner of the overlaid plot window 601 in order to close it and better show the scatter plot window 300A and the data view window 300C as shown in FIG. 5A.

FIGS. 7A, 7B, 7C, and 7D show additional tools available in the platform for model analysis based on traditional statistical results. These methods complement the novel error-featurization method. In the case that the AI model is of classification type, one or more of a plurality of interactive statistical charts can be displayed. An interactive bar chart of histograms (see FIG. 7C) illustrating prediction confidences can be displayed. An interactive line plot of precision versus recall (see FIG. 7D) can be displayed. An interactive matrix plot (a heatmap) of a confusion matrix (see FIG. 7E) can be displayed.

FIG. 7A shows the user interface (UI) window 700, which is produced by clicking the ‘up arrow’ button 361 in the window 300. The UI window 700 includes the scatter plot window 300A, data view window 300C, and statistics view window 300D. The statistics view window 300D is expanded in window 700, while the scatter plot window 300A is collapsed. Clicking the up-arrow button 362 reverts back to window 300 with the scatter plot window 300A expanded.

The statistics window 300D includes the histogram window 701, confidence threshold selection window 702, the precision-recall window 703, and additionally the confusion matrix window 704. The confusion matrix window 704 is not in view in FIG. 7A but can be reached by scrolling down in the statistics view window 300D and is shown in FIG. 7B.

FIG. 7B shows the confusion matrix window 704 which is reached after scrolling through the statistics view window 300D. This may lead to the histogram window 701, confidence threshold selection window 702, and part of the precision-recall window 703 to be hidden from view.

FIG. 7C shows the interactive histogram window 701, a bar chart, which is part of the statistics view window 300D. The histogram window 701 is further comprised of a class selection window 710 and a histogram chart window 712. The class selection window 710 includes options to select all classes 711A-711F or one of the classes to display in the histogram. The histogram chart window 712 plots the histogram for the prediction confidences versus the number of samples for the class or classes that are selected in the class selection window 710. A user can select a bar in the bar chart to illustrate prediction confidences.

FIG. 7D shows the confidence threshold selection window 702 and the precision-recall window 703, which are both part of the statistics view window 300D. The confidence threshold selection window 702 contains a slider widget (menu) that can be used to select a lower value of the confidence threshold for the range between the confidence threshold value and one. This lower confidence threshold value is used to highlight a marker 723 in the precision-recall curve chart 722 in the precision-recall window 703. The precision-recall curve chart 722 also includes a line plot 724, which shows the values of precision-recall over all values of the confidence threshold range from 0.0 to 1.0.

FIG. 7E shows the confusion matrix window 704, which is part of the statistics view window 300D. The confusion matrix is a traditional analysis tool that shows the number of samples belonging to a specific ground-truth class being assigned by the model to a specific predicted class. For instance, cell 730A in FIG. 7E shows the number of samples (six) belonging to the ground-truth class of ‘cat’ that were predicted by the model as belonging to the class ‘butterfly’. Various shades of a color are shown in the cells of the confusion matrix to illustrate different values to provide information as a heat map. The higher the number of samples assigned (e.g., 3.7K with cell in lower right hand corner), the darker the shade of the color (e.g., dark purple) in the cell. The lower the number of samples that are assigned (e.g., six with cell 730A), the lower is the shade (e.g., nearly clear) of the color in the cell. A user can select data in the confusion matrix by selecting a row, a column, a diagonal, or an individual cell. Selecting a cell in the confusion matrix provides an illustration of predicted confidences versus intersection over union (IoU) scores.

For the case of object detection, the user interface changes only in the presentation of labels associated with the images. FIG. 4B shows the object detection version of FIG. 4A. The new UI window 410, corresponding to the window 400 for classification, generated by hovering over a data point presents object detection labels as zero or more (or one or more) instances of ground truth objects (and/or annotations), along with confidence scores (resultant model output or resultant output in parenthesis) associated with zero or more (or one or more) instances of predictions. Similarly in FIG. 5B, within the UI window 510, the data view window 300C shows all of the related images of the clicked point in the plot view window 501. The inset window 514 showing the labels associated with the image change to the object detection case, showing zero or more instances of ground truth objects and zero or more instances of predicted objects along with the prediction confidences. All other components of the UI remain the same. FIG. 5C shows an enlarged view of an image selected in the data view window 300C, by clicking on the window expansion icon (doubled headed arrow icon) in the control icons 553. The user interface displays a high-resolution image and any annotations on the image when the window expansion icon is selected. The user interface can further display entries in the resultant model output for the high-resolution image. FIG. 5C shows all of the object annotations (bounding boxes around objects or labels) in the ground truth and predictions along with the associated bounding boxes localizing these objects in the image. The annotations are expressed through the bounding boxes overlaid on the image 521. In FIG. 5C, a solid line bounding box can be used for ground-truth annotations such as a ground truth bounding box 522A around an object in the image, such as a person as shown. A dashed line bounding box can be used for prediction annotations such as a prediction bounding box 522B around an object in the image, such as the horse as shown. Additionally, a legend for the object classes 523 identifies the classes (e.g., horse, person) to which each overlaid bounding box belongs.

In the case of object detection, one or more similar statistic charts can be used to those shown in FIGS. 7A-7E but can be formed using intersection over union (IoU) scores in addition to the sample number score. An interactive bar chart of histograms (similar to FIG. 7C) illustrating prediction confidences versus intersection over union (IoU) scores can be displayed. An interactive line plot of precision versus recall (similar to FIG. 7D) can be displayed using intersection over union (IoU) scores. An interactive matrix plot (with a heatmap) of a confusion matrix (similar to FIG. 7E) can be displayed using intersection over union (IoU) scores. Similar to that shown in FIG. 7D, an IoU confidence threshold selection window can display a slider widget (menu) that can be used to select a lower value of the IoU confidence threshold for the range between the IoU confidence threshold value and one. The range is used to filter out the IoU scores that are used to form the interactive matrix plot and the confusion matrix that correspond to images whose IoU score falls within the IoU range set by the lower IoU confidence threshold value.

### Model Analysis Workflow

Referring now back to FIGS. 2A-2B, the goal of ML model analysis is to provide insights into model failure modes. The insights into model failure modes can be used for targeted data curation in subsequent training iterations of the ML model. After the cycle of fitting process 204 and evaluation process 205 is complete, a model analysis process 206 by a model analysis platform can be performed.

The workflow to add a test dataset and its associated labels, along with job parameters for the analysis job, to the model analysis platform is now described.

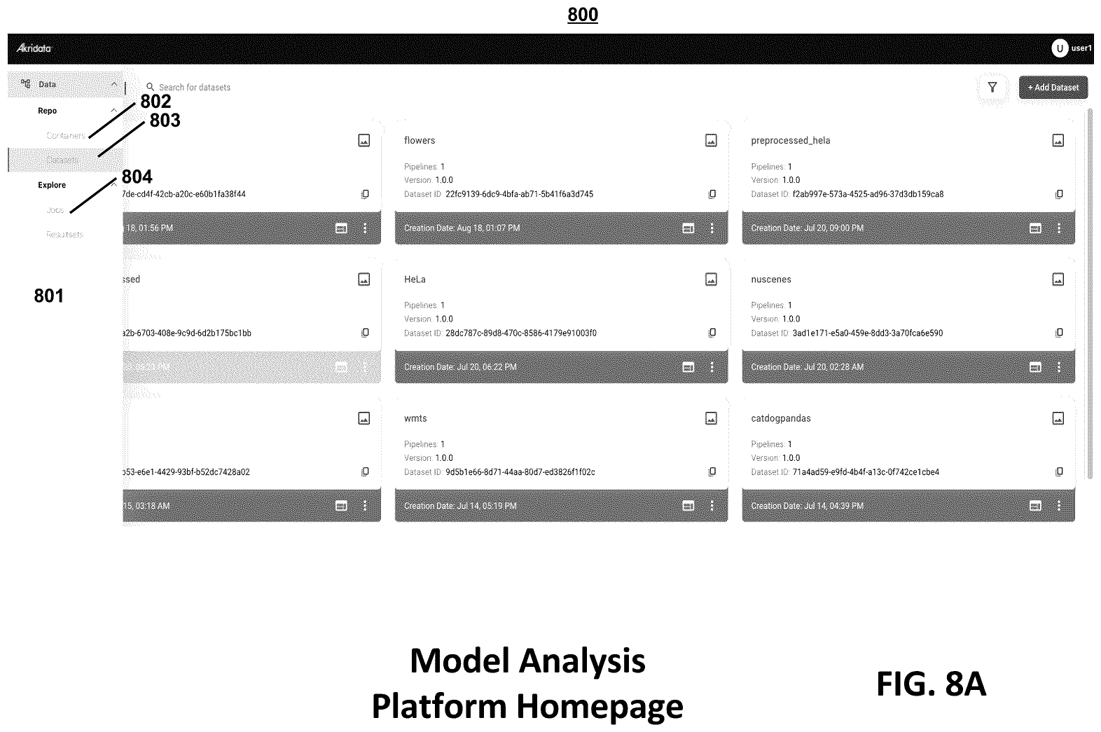

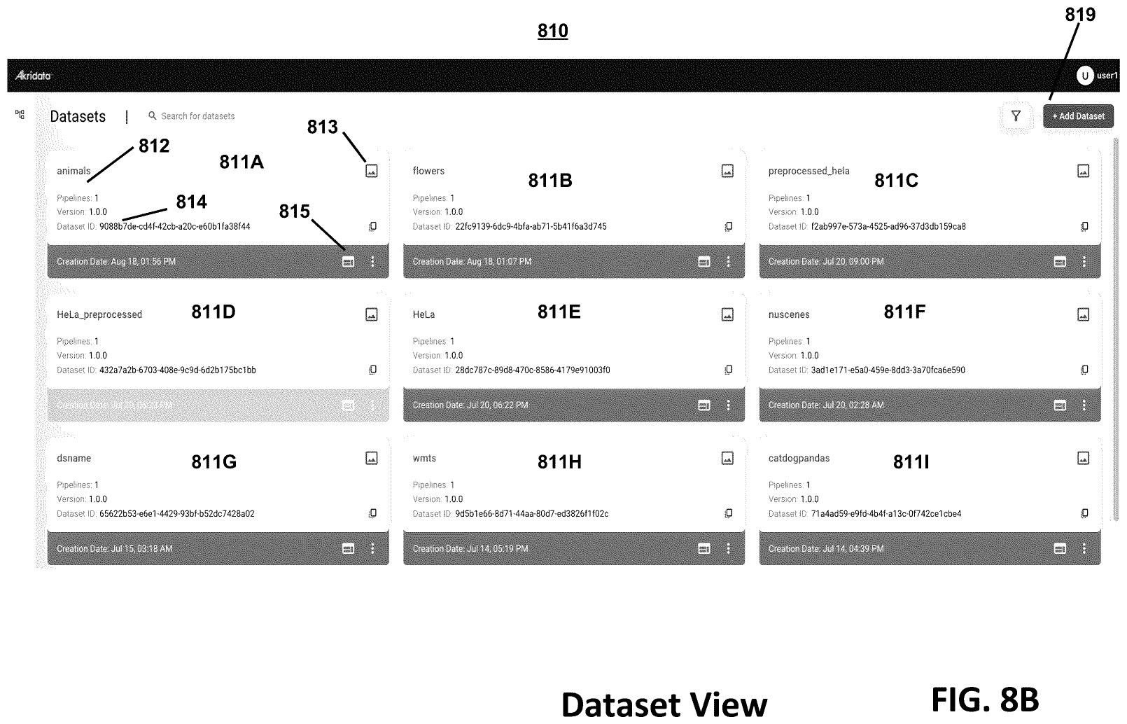

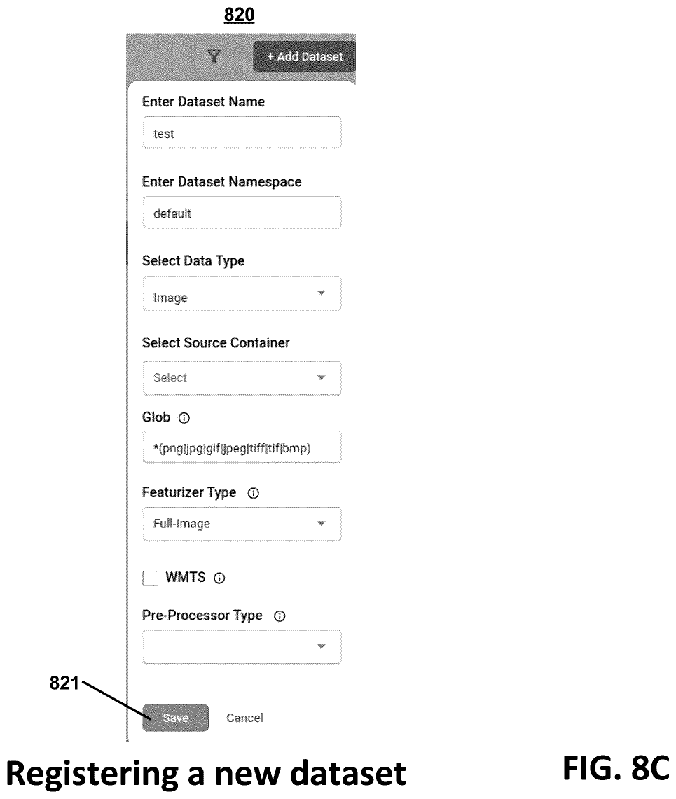

FIG. 8A shows the homepage window 800 of the model analysis platform. The homepage window 800 contains a collapsible sidebar 801, which includes the ‘Containers’ button 802, the ‘Datasets’ button 803, and the ‘Jobs’ button 804, among others, to navigate to different user interface windows. These buttons produce other user interface windows that allow a user to organize multiple datasets available at multiple sources in order to view and add datasets and to view and add model analysis jobs.

FIG. 8B shows the datasets view window 810, generated when the user clicks on the datasets button 803 in the homepage window 800. The datasets view window 810 lists all available existing datasets provided by a user, shown as dataset or user interface (UI) cards 811A-811I. Each dataset or UI card can have differing selectable user interface icons displayed near each image. Each dataset or UI card, such as UI card 811A, contains information such as the dataset name 812, the dataset type icon 813, and additional metadata fields 814. The dataset card also includes a catalog table icon 815. Differing selectable user interface icon of each user interface card can support additional user interface actions including removing a user interface card, enlarging the image of the user interface card, displaying associated labels of the user interface card, and marking the image of the user interface card as a sample of interest.

A new dataset can be registered by a user by clicking a user interface button, such as the ‘Add dataset’ button 819. Selection of the ‘Add dataset’ button 819 generates a popup dataset registration window 820 shown in FIG. 8C for registering a new dataset. The dataset registration window 820 takes details such as the dataset name, dataset type, source (location on disk or cloud storage), format, and additional processing options. The user clicks the ‘Save’ button 821 to register and process the new dataset.

In FIG. 2C, where the inference process 216 happens outside the model analysis platform, the ML model analysis process 206 and platform receives a test dataset from the image collection process 201. Like all data sets of images, the test dataset is indexed by assigning a unique ID to each data point associated with each image in the test dataset. The unique IDs of the data point associated with the images are used for later reference by the model analysis platform in a catalog of images.

At an inference process 216, the model analysis process is initiated with an inference module. During the inference process 216, each data point in the test dataset is run through the AI machine using the fitted classification model to obtain prediction confidence scores for each class in the classification problem The class-wise prediction confidence scores are usually referred to as just predictions.

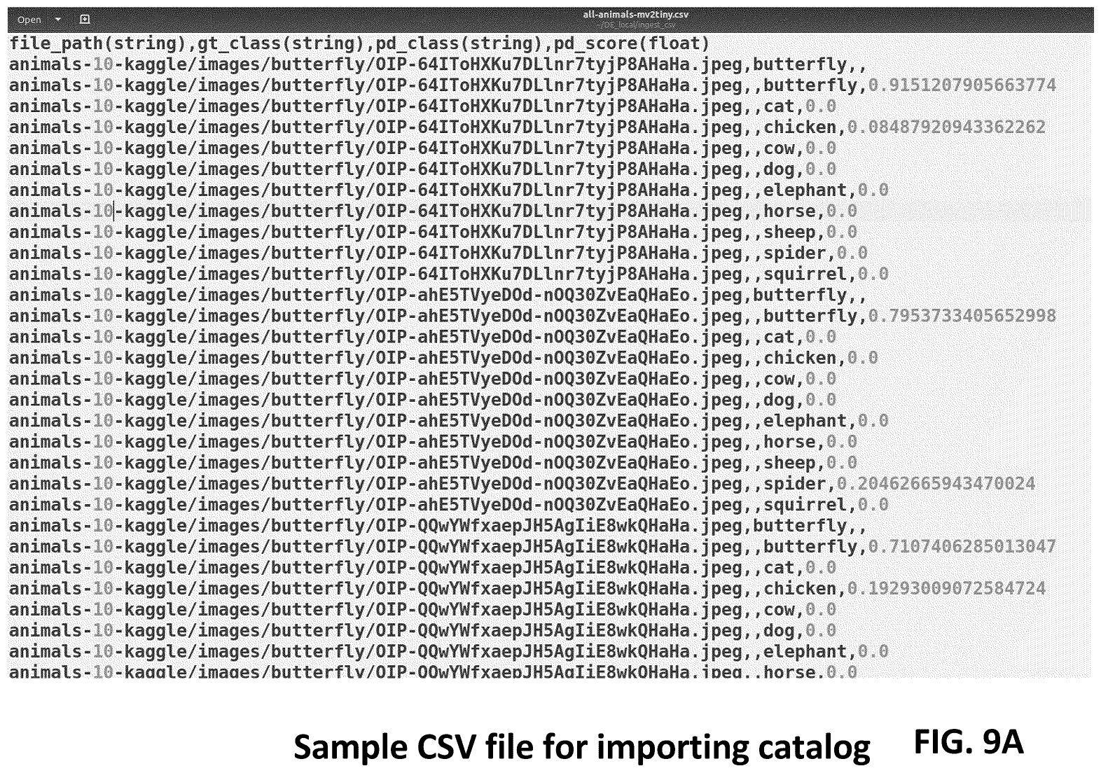

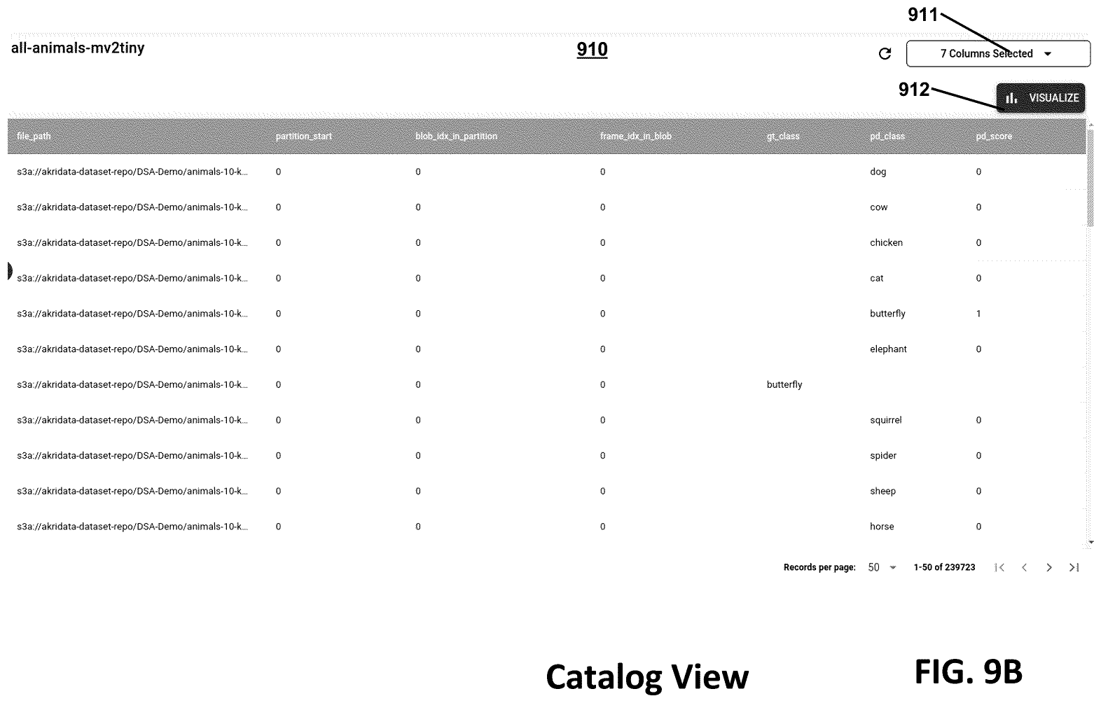

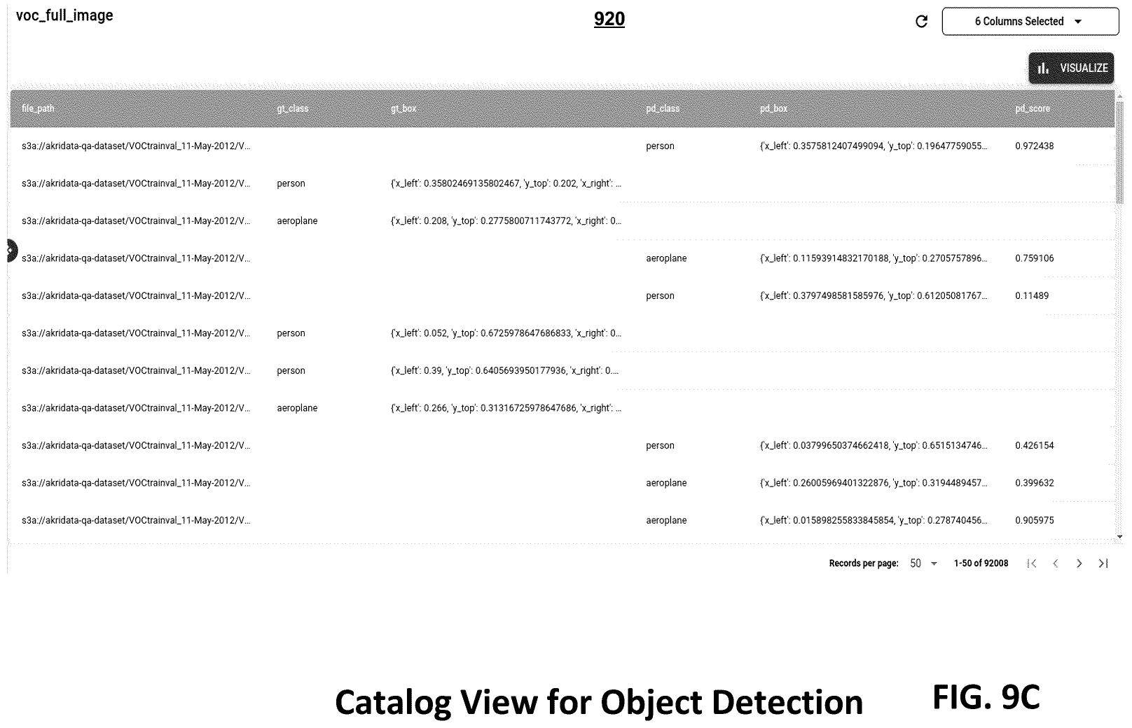

FIG. 9A illustrates a sample label input into the model, provided in the ‘Comma-Separated Values’ (CSV) format. Each row in this input file refers to the data sample through the file_path and provides either the GT label through the gt_class column, or the predicted label through the pd_class (predicted class) and pd_score (confidence associated with this predicted class) columns. The values for the ‘file_path’ column must correspond to the image dataset previously registered with the model analysis platform, as described in FIG. 8C.

The test dataset with its associated labels are stored in a database catalog and can be viewed in the catalog view window 910, as shown in FIG. 9B, by clicking on the catalog table icon 815 associated with any dataset such as 811A-811I in the datasets view window 810. In addition to the ‘filepath’ supplied in the label input in FIG. 9A, the database catalog creates additional columns ‘partition_start’, ‘blob_idx_in partition’, and ‘file_idx_in_blob’ to index the dataset for later reference. The available columns can be toggled by the user to view only the relevant ones by using the column selection dropdown or pulldown menu 911. Creation of a model analysis job can be triggered by clicking on the ‘Visualize’ button 912.

FIG. 9C shows the catalog view window 920 corresponding to the problem of object detection. The labels for the object detection problem are different from those for the classification problem and are hence expressed through different columns in the catalog table.

A model analysis job (also called a visualization job) for the label data as in FIG. 9B is triggered by clicking on the ‘Visualize’ icon 912 in the catalog view window 910. FIG. 10A shows the job creation window 1000 that pops up when the visualize icon 912 is clicked. The job creation window 1000 contains an editable job name field 1001 and a create button 1002. After the job name is entered and the create button 1002 is clicked, a model analysis job is created.

A newly created model analysis job takes additional parameters from the user to define the job. These are inputted through the job submission window 1010 shown in FIG. 10B, which is produced by clicking the create button 1002 in the job creation window 1000. The job submission window 1010 takes three groups of user inputs, with the group of input specified using the Job Parameters button 1011, Columns button 1012, and the Advanced Options button 1013. The Job Parameters button 1011 produces the basic job parameters window 1015, which includes three dropdown or pulldown menus: Job type menu 1015A, clustered selection menu 1015B, and embedder selection menu 1015C. The basic job parameters window 1015 also includes the next button 1015D to move to the column's selection window 1016. The columns selection window 1016 similarly has three dropdown menus, ground truth column selection menu 1016A, prediction column selection menu 1016B, and confidence column selection menu 1016C, along with the next button 1016D to move to the advanced options selection window 1017. The advanced options selection window 1017 has two dropdown or pulldown menus, visualization quality menu 1017A and clustering order menu 1017B, and a submit button 1017C. Clicking the submit button 1017C completes the job submission process.

FIG. 10E shows the jobs screen window 1020, which is generated by clicking the jobs button 804 in the homepage window 800. The jobs screen window 1020 lists all the existing jobs submitted by the user as user interface (UI) cards or job cards 1021A-10211 that can display information of existing model analysis jobs. Each job card, such as card 1021A, includes the job name 1022 and further details of an existing job such as the job status 1023A. Each job card can further include a job type icon 1023B, basic job parameters 1024, job metadata 1025, and an action button 1026 that either visualizes a processed job or submits a job for further processing. The jobs screen window 1020 also includes a series of filtering tools in the job filter window 1030 that can filter the model analysis jobs based on dataset type, job type, and processing status, among other options. Pulldown menus can be used by a user to select how the jobs can be filtered out. Selecting the action button 1026, a user interface button, on a card allows a user to visualize the corresponding model analysis job.

The known true labels and the model predictions by the ML model for the test dataset, along with the associated IDs of each data point, are then sent to a featurization module to run a featurization process 217. The featurization module receives featurization parameters as a user input via the user interface 219 and the UI input devices 210. These featurization parameters include the relative importance of object classes as relevant to the business case. The relative importance of an object class is indicated by a binary selection of a subset of all the object classes, a grouping of object classes of interest, or one or more selected levels in a hierarchy of object classes.

The featurization module 217 produces high-dimensional feature representations for each data point associated with each image. These feature representations and associated data point IDs are passed to the ‘Reduction and Clustering’ module 218. The image features can be determined by a content of the images. In another case, the image features can be determined by a class-wise evaluation of a divergence between ground truth class-labels and model prediction confidences in the case of image classification.

The Reduction and Clustering process 218 performed by the ‘Reduction and Clustering’ module produces 2-dimensional embeddings from the feature representations. These 2-dimensional embeddings can be viewed as a scatterplot, such as the scatter plot shown in the scatter plot window 300A. Clustering is also performed on the 2-dimensional embeddings to capture grouping within the data points. A clustering algorithm can be selected to group data points together such as a hierarchical density-based spatial clustering (HDBSCAN) algorithm, a k-segmentation algorithm, a hierarchical k-means algorithm, and/or a gaussian mixture model algorithm. An embedding algorithm can be selected to plot and display data points in two dimensions such as a uniform manifold approximation and projection for dimension reduction (UMAP) algorithm, a principal component analysis (PCA) algorithm, and/or a locally linear embedding algorithm. In some embodiments, the plurality of data points are shown clustering together in clusters based on distances between image features.

The user interface process 219 and module receives the 2-dimensional embeddings and associated cluster labels from the reduction and clustering module 218, along with the unique data point IDs. The user-interface process 219 and module also gets the test images and annotations from 216, along with the unique data point IDs. The data point IDs allow the clustered embeddings and the labeled images to be correlated and displayed to the user.

The UI process 219 and module allows users to interactively explore and browse through the error plot view of model failures to identify frequent failure modes. The UI process 219 and module allows users to interactively look for underlying patterns in the images causing these failures. Displaying the images causing failures with the ML model generates insight into the kind of images that can be problematic for the ML model.

### Featurizing Model Errors

ML model errors are determined for each data point by comparing the ground truth label and predicted confidence scores. The featurization process 217 performed by the featurization module creates high-dimensional feature representations for the unique data points using the model-errors. The feature representations are then sent to the reduction and clustering process 218 to reduce them to two dimensional-embeddings and clustered for display in the error plot view.

The model-error-feature-representation for each data point is calculated as follows. Initially, a one-hot-encoding of the true class label for each data point is performed to generate a vector y_true_one_hot.

The inference process 216 provides per-class confidence scores for the underlying image associated with each data point y_pred_confidence.

An error_feature_vector for the given data point is generated by calculating the difference between the two vectors. That is, the error_feature_vector=(y_pred_confidence−y_true_one_hot).

As an example, consider a five-class classification problem with the ordered classes: [‘cat’, ‘cow’, ‘dog’, ‘horse’, ‘rabbit’]. Suppose an image of a ‘cat’ (true label), after inference using the image classification model of interest, produces confidence scores of [0.1, 0.1, 0.2, 0.1, 0.5] for the ordered classes. The error feature vector for this data point will be the difference of the above confidence score vector and the one-hot-encoding of the true label ‘cat’ [1, 0, 0, 0, 0]. The calculated difference produces [0.9, −0.1, −0.2, −0.1, −0.5] for the error feature vector.

During the featurization process, the mapping of data points (images) to their unique IDs is maintained by the featurization module.

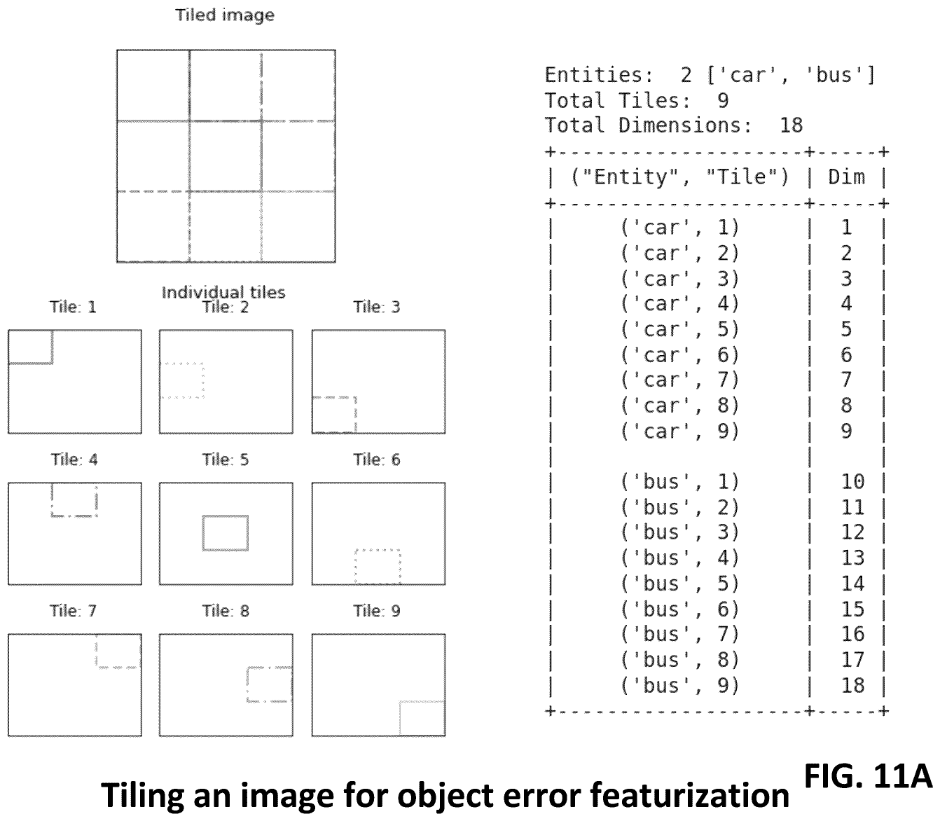

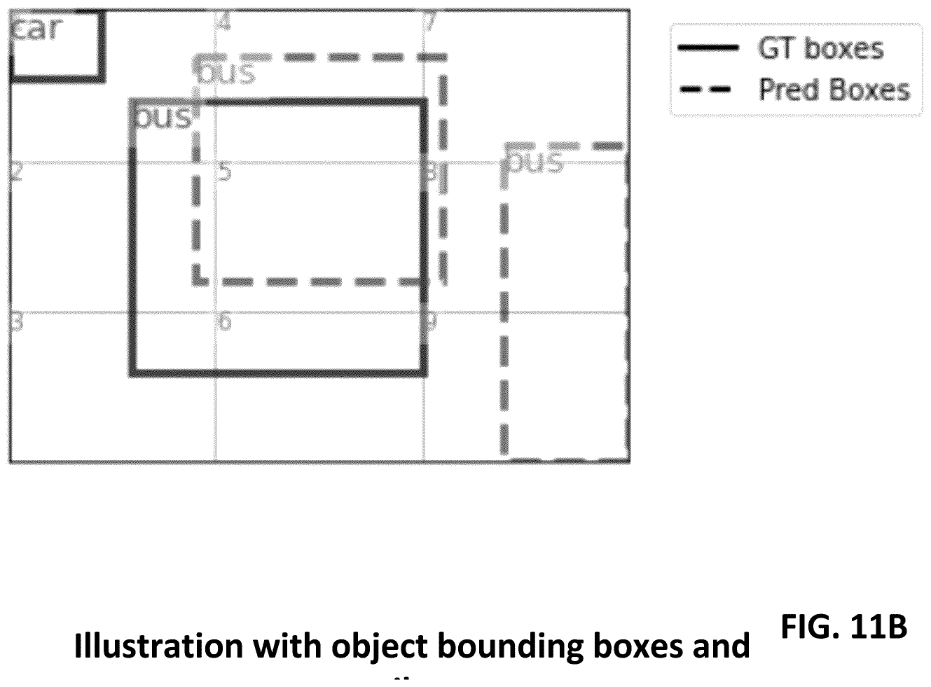

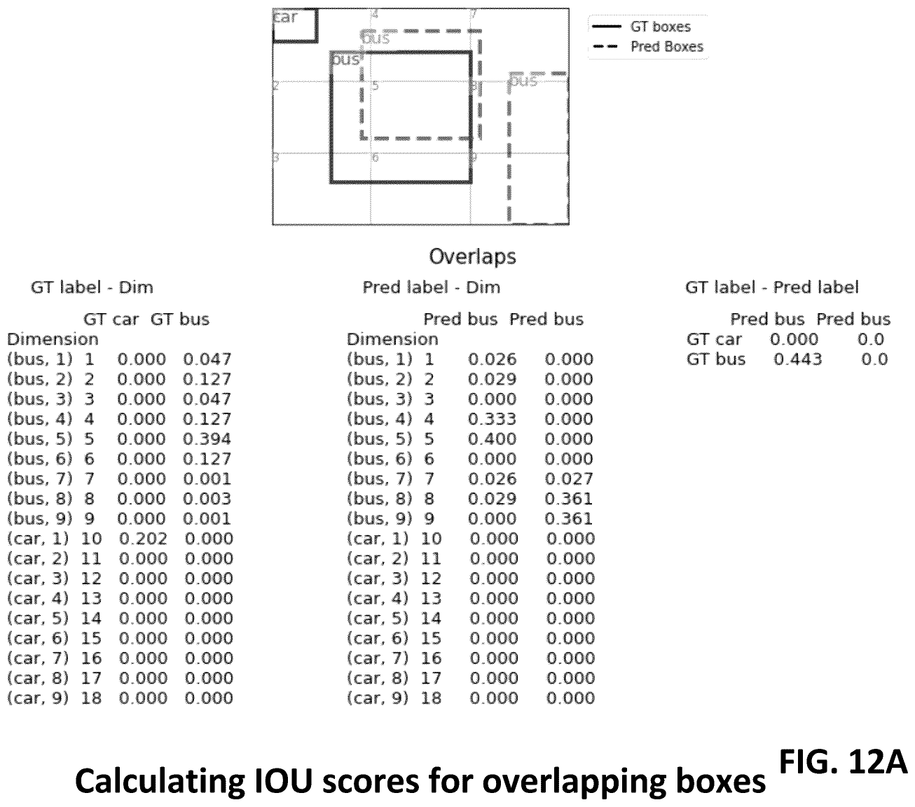

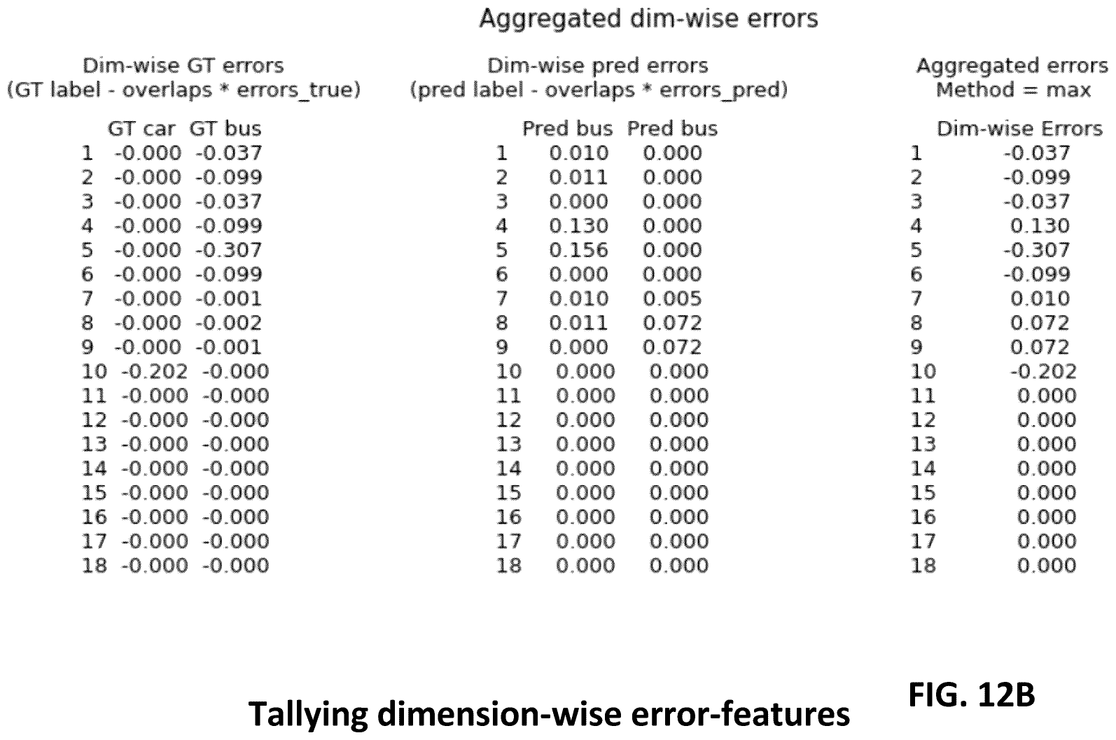

For the case of object detection, the featurization process 217 uses object detection labels of zero or more ground truth classes with bounding boxes and zero or more prediction classes with bounding boxes to produce the feature representations. Instead of one class getting one feature dimension as in classification, each combination of an object class and a region in the image gets a feature dimension. One featurization scheme is now described. FIG. 11A imposes a 3×3 grid on the image to separate errors between grid cells; each combination of (object-entity, tile) is allocated a feature dimension. FIG. 11B shows an illustrative sample that has two ground truth (GT) boxes (solid lines) for ‘car’ and ‘bus’ objects, and two predicted boxes (dashed lines) for ‘bus’ and ‘bus’ objects. FIG. 12A shows calculation of Intersection-Over-Union (IOU) scores for overlaps between each pair of GT label boxes, Predicted label boxes, and feature dimensions. FIG. 12B shows the contributions to each of the feature dimensions in three columns. The first column on the left shows contributions due to each of the GT boxes alone. The second column in the middle shows contributions due to each of the Predicted boxes alone. The third column on the right shows the final features obtained by aggregating (maximum of absolute values) over the dimension-wise values over contributions due to each of GT and predicted boxes. The output of the featurization process 217 is the third column of FIG. 12B, the aggregated dimension-wise errors. Other schemes are possible with different grids, with or without overlap, and using different aggregation methods.

### Reduction and Clustering

The reduction and clustering process 218 by the reduction and clustering module takes a feature matrix that contains high-dimensional feature vectors for each data point of a plurality of data points in the test dataset. The reduction and clustering process 218 generates two dimensional (2d-) embeddings along with cluster labels for each feature vector to form clustered 2d-embeddings of data points. The unique ID for each data point is maintained and tracked. The clustered 2d-embeddings populate the scatter plot in the errorPlot View on the UI; the point IDs are used to fetch images associated with the points on the scatter plot.

The reduction process is performed on the feature matrix using a dimensionality reduction method, such as ‘Uniform Manifold Approximation and Projection for Dimension Reduction’ (UMAP) or ‘Principal Component Analysis’ (PCA). This produces a 2-dimensional representation for each data point.

The clustering process is then done on the 2-dimensional representation of the test dataset and assigns an integer-valued cluster-label to each data point. The clustering is performed using known popular methods such as Hierarchical Density-Based Spatial Clustering (HDBSCAN), K-Means, etc. In the error plot view of the UI windows, all data points with the same cluster label are displayed with the same color.

### Example Application

The UI windows of FIGS. 4A, 5A, and 6A illustrate a collection of images with cows whose faces were the focus of the images, or cows lying down with their heads tucked towards their feet. For all of these images, the ML multiclass model mis-predicted the images to be that of a dog class and not a cow class. The model analysis process with the model analysis platform allows a number of potential actions to be taken following this observation. The mis-prediction informs the user of a model failure mode. The view of all the images indicates that the ML model confuses cow images to be images of dogs when the faces are in focus. The user can verify this by adding more cow images with faces in focus to the test dataset.

The user can consider the impact of this model failure mode on the business case or operational use of the ML model. The user can choose to ignore the model failure mode (and remove the associated data points from the test set), if this doesn't impact their application. Alternatively, the user can fix the failure mode immediately in the ML model by adding more examples of this scenario. Or, the user can fix the failure mode at a lower priority, after addressing other failure modes that may be critical to the operational use of the ML model.

### Computer Network

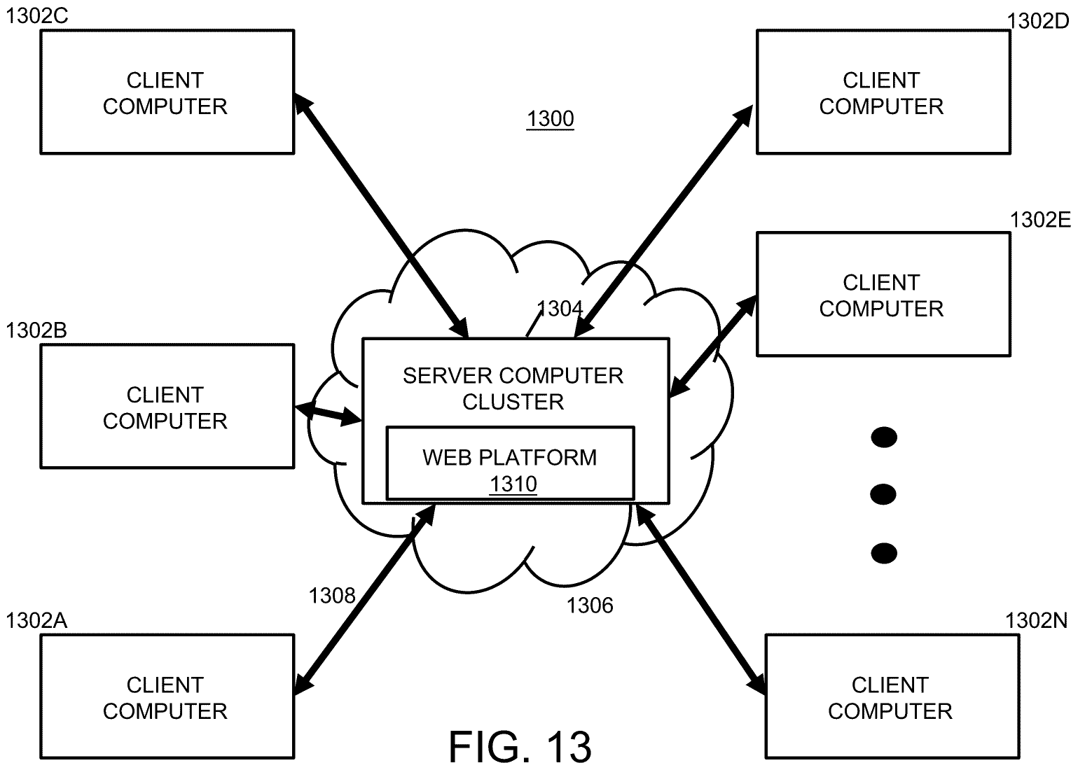

Referring now to FIG. 13, a block diagram of a client-server computer system 1300 is shown. The client-server computer system 1300 includes a plurality of client computers 1302A-1302N in communication with one or more computer servers 1304 that are clustered together in a server center (or the cloud) 1306 over a computer network 1308, such as a wide area network of the internet. The web-based scalable ML model analysis platform 1310 for computer vision models can be executed on the one or more computer servers 1304 for access by the plurality of client computers 1302A-1302N to perform the operations required by the model analysis process 206. To provide the neural network nodes, the computer servers 1304 can use a plurality of graphical processing units (GPUs) that can be flexibly interconnected to process input image data and generate the desired output results established by the AI models.

### Computer System

Referring now to FIG. 14, a block diagram of a computing system 1400 is shown that can execute the software instructions for the web-based ML model analysis platform 1310 for computer vision models. The computing system 1400 can be an instance of one or more servers executing stored software instructions to perform the functional processes described herein. The computing system 1400 can also be an instance of a plurality of instances of the client computers in the wide area network executing stored software instructions to perform the functional processes described herein of a client computer to provide and display a web browser with the various window viewers described herein.

In one embodiment, the computing system 1400 can include a computer 1401 coupled in communication with a graphics monitor (display device with a display screen) 1402 with or without a microphone. The computer 1401 can further be coupled to a loudspeaker 1490, a microphone 1491, and a camera 1492 in a service area with audio video devices. In accordance with one embodiment, the computer 1401 can include one or more processors 1410, memory 1420; one or more storage drives (e.g., solid state drive, hard disk drive) 1430,1440; a video input/output interface 1450A; a video input interface 1450B; a parallel/serial input/output data interface 1460; a plurality of network interfaces 1461A-1461N; a plurality of radio transmitter/receivers (transceivers) 1462A-1462N; and an audio interface 1470. The graphics monitor 1402 can be coupled in communication with the video input/output interface 1450A. The camera 1492 can be coupled in communication with the video input interface 1450B. The speaker 1490 and microphone 1491 can be coupled in communication with the audio interface 1470. The camera 1492 can be used to view one or more audio-visual devices in a service area, such as the monitor 1402. The loudspeaker 1490 can be used to communicate out to a user in the service area while the microphone 1491 can be used to receive communications from the user in the service area.

The data interface 1460 can provide wired data connections, such as one or more universal serial bus (USB) interfaces and/or one or more serial input/output interfaces (e.g., RS232). The data interface 1460 can also provide a parallel data interface. The plurality of radio transmitter/receivers (transceivers) 1462A-1462N can provide wireless data connections such as over WIFI, Bluetooth, and/or cellular. The one or more audio video devices can use the wireless data connections or the wired data connections to communicate with the computer 1401.

The computer 1401 can be an edge computer that provides for remote logins and remote virtual sessions through one or more of the plurality of network interfaces 1461A-1461N. Additionally, each of the network interfaces support one or more network connections. Network interfaces can be virtual interfaces and also be logically separated from other virtual interfaces. One or more of the plurality of network interfaces 1461A-1461N can be used to make network connections between client computers and server computers.

One or more computing systems 1400 and/or one or more computers 1401 (or computer servers) can be used to perform some or all of the processes disclosed herein. The software instructions that perform the functionality of servers and devices are stored in the storage device 1430,1440 and loaded into memory 1420 when being executed by the processor 1410.

In one embodiment, the processor 1410 executes instructions residing on a machine-readable medium, such as the hard disk drive 1430, solid state drive 1440, or a combination of both. In a server, the video interfaces 1450A-1450B can include a plurality of graphical processing units (GPUs) that are used to execute instructions to provide the neural network nodes for the AI neural network in order to perform the functions of the disclosed embodiments. The instructions can be loaded from the machine-readable medium into the memory 1420, which can include Random Access Memory (RAM), dynamic RAM (DRAM), etc. The processor 1410, 1450A-1450B can retrieve the instructions from the memory 1420 and execute the instructions to perform operations described herein.

Note that any or all of the components and the associated hardware illustrated in FIG. 14 can be used in various embodiments of a computer system 1400. However, it should be appreciated that other configurations of the computer system 1400 can include more or less devices than those shown in FIG. 14.

### Advantages

The traditional model iteration process of fit-evaluate-deploy without model analysis does not include the association of errors with the underlying image and annotation data. This makes it hard for an ML practitioner to identify the root cause of model failure modes, and consequently makes it difficult to curate relevant data or improve processes for subsequent model refinement steps. Analysis of model failure modes with the model analysis platform allows targeted curation and training, along with fine-tuning of annotation and evaluation of the ML model. The model analysis platform leads to reduced time and cost for annotation of ML mode. The model analysis platform provides reduced model fitting time and computational cost, and higher quality training data for the ML model. This leads to more robust training outcomes of the ML model.

The aggregate benefit of the targeted refinement can, at worst, reduce the time and cost by orders of magnitude because of the reduction in the quantity of training data for similar outcomes. At best, the higher quality data can make it feasible to completely eliminate critical failure modes, which may not be possible without targeted training.

### Closing

Some portions of the preceding detailed description have been presented in terms of algorithms and symbolic representations of operations on data bits within a computer memory. These algorithmic descriptions and representations are the tools used by those skilled in the data processing arts to effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The embodiments are thus described. While certain exemplary embodiments have been described and shown in the accompanying drawings, it is to be understood that such embodiments are merely illustrative of and not restrictive on the broad invention, and that the embodiments are not limited to the specific constructions and arrangements shown and described, since various other modifications may occur to those ordinarily skilled in the art.

When implemented in software, the elements of the disclosed embodiments are essentially the code segments to perform the necessary tasks. The program or code segments can be stored in a processor readable medium or transmitted by a computer data signal embodied in a carrier wave over a transmission medium or communication link. The “processor readable medium” may include any medium that can store information. Examples of the processor readable medium include an electronic circuit, a semiconductor memory device, a read only memory (ROM), a flash memory, an erasable programmable read only memory (EPROM), a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded using a computer data signal via computer networks such as the Internet, Intranet, etc. and stored in a storage device (processor readable medium).

While this specification includes many specifics, these should not be construed as limitations on the scope of the disclosure or of what may be claimed, but rather as descriptions of features specific to particular implementations of the disclosure. Certain features that are described in this specification in the context of separate implementations may also be implemented in combination in a single implementation. Conversely, various features that are described in the context of a single implementation may also be implemented in multiple implementations, separately or in sub-combination. Moreover, although features may be described above as acting in certain combinations and even initially claimed as such, one or more features from a claimed combination may in some cases be excised from the combination, and the claimed combination may be directed to a sub-combination or variations of a sub-combination. Accordingly, while embodiments have been particularly described, they should not be construed as limited by such disclosed embodiments.

1-20. (canceled)

21. An apparatus for verification and analysis of artificial intelligence (AI) models, the apparatus comprising:
a display device having a display screen that is configured to display a first user interface (UI) including:
a scatter plot window showing an aggregate view of a plurality of data points associated with images forming a scatter plot; and
a plurality of statistical charts providing information about prediction performance of an AI model over the images.

22. The apparatus of claim 21, wherein the first user interface further includes:
a data view window showing a plurality of images each having one or more associated machine learning labels based on a selection of one or more data points in the scatter plot or a selection of data in a statistical chart.

23. The apparatus of claim 22, wherein:
the AI model is of a classification type and the plurality of statistical charts includes one or more of the group comprising:
an interactive bar chart of histograms illustrating prediction confidences;
an interactive line plot of precision versus recall; and
an interactive matrix plot for a confusion matrix.

24. The apparatus of claim 23, wherein:
the first user interface (UI) further displays a slider menu to select a lower prediction confidence threshold for a range of prediction confidence thresholds from the lower prediction confidence threshold to a maximum of one; and
a selection of the lower prediction confidence threshold with the slider menu results in changes to the interactive line plot of precision versus recall and the interactive matrix plot for the confusion matrix to correspond to the images whose prediction confidence falls within the selected range.

25. The apparatus of claim 22, wherein:
the AI model is of object detection type and the plurality of statistical charts includes one or more of the group comprising:
an interactive matrix plot illustrating prediction confidences versus intersection over union (IoU) scores;
an interactive line plot of precision versus recall; and
an interactive matrix plot for a confusion matrix.

26. The apparatus of claim 25, wherein:
the first user interface (UI) further displays a first slider menu to select a lower prediction confidence threshold value for a first range of prediction confidence thresholds and a second slider menu to select a lower IoU score threshold value for a second range of IoU score thresholds; and
wherein a selection of the first slider menu results in changes to the interactive line plot of precision versus recall and the interactive matrix plot for the confusion matrix to correspond to images whose prediction confidence falls within the first range;
wherein a selection of the second slider menu results in further changes to the interactive line plot of precision versus recall and the interactive matrix plot for the confusion matrix to correspond to images whose IoU score threshold falls within the second range.

27. The apparatus of claim 21, wherein:
the plurality of data points are shown clustering together in clusters based on distances between image features.

28. The apparatus of claim 27, wherein:
the image features are determined by a class-wise evaluation of a divergence between ground truth class-labels and model prediction confidences in the case of image classification.

29. The apparatus of claim 27, wherein:
the image features are determined by a content of the images.

30. The apparatus of claim 22, wherein:
the one or more associated machine learning labels includes at least one classification label.

31. The apparatus of claim 22, wherein:
the one or more associated machine learning labels includes at least one object class and location label.

32. The apparatus of claim 22, wherein:
the one or more associated machine learning labels includes a ground truth label, a predicted label, or both a ground truth label and a predicted label.

33. The apparatus of claim 21, wherein:
the scatter plot window further includes:
an inset window including a legend with interactive buttons to control the scatter plot of the data points.

34. The apparatus of claim 21, wherein:
the scatter plot window further includes:
a plurality of option buttons to filter, sample, and view images corresponding to the data points in the scatter plot.

35. The apparatus of claim 22, wherein:
the data view window further includes associated with each image of the plurality of images:
a plurality of differing selectable user interface icons displayed near each image to form a user interface (UI) card; and
wherein each differing selectable user interface icon of each user interface card supports additional user interface actions including removing a user interface card, enlarging the image of the user interface card, displaying associated labels of the user interface card, and marking the image of the user interface card as a sample of interest.

36. The apparatus of claim 35, wherein:
the data view window further includes:
a plurality of control buttons to control a number of UI cards, a resetting of UI cards, a highlighting of corresponding samples in the scatter plot, and a controlling of samples that get populated into the UI cards.

37. The apparatus of claim 35, wherein:
a selectable user interface icon of a UI card is selected that enlarges the image of the user interface card, the first user interface displays:
a high-resolution image;
annotations on the high-resolution image; and
detailed parameters of the prediction performance of the AI model for the selected image.

38. The apparatus of claim 23, wherein:
the selection of data in a statistical chart comprises:
the selection of a bar in an interactive bar chart of histograms illustrating prediction confidences.

39. The apparatus of claim 23, wherein:
the selection of data in a statistical chart comprises:
the selection of a row, a column, a diagonal, or an individual cell in an interactive matrix plot for the confusion matrix.

40. The apparatus of claim 25, wherein:
the selection of data in a statistical chart comprises:
the selection of a cell in an interactive matrix plot illustrating prediction confidences versus intersection over union (IoU) scores.

41. The apparatus of claim 25, wherein:
the selection of data in a statistical chart comprises:
the selection of a row, a column, a diagonal, or an individual cell in an interactive matrix plot for the confusion matrix.

42. The apparatus of claim 21, further comprising:
the display device having a display screen that is configured to display a second user interface window including:
a collapsible sidebar with buttons to navigate to different user interface windows to view and add datasets, and to view and add model analysis jobs.

43. The apparatus of claim 42, further comprising:
the display device having a display screen that is configured to display a third user interface window including:
a plurality of UI cards displaying information on existing datasets;
with each UI card containing name and details of existing datasets; and
a UI button to add a new dataset.

44. The apparatus of claim 43, further comprising:
the display device having the display screen that is configured to display a fourth user interface window including:
a pull-down menu for selection of one of a plurality of database catalog columns;
a table displaying values in a database catalog; and
a button to visualize the model performance associated with the table as a model analysis job.

45. The apparatus of claim 44, further comprising:
the display device having the display screen that is configured to display a fifth user interface window including:
one or more pulldown menus to select job parameters and database columns.

46. The apparatus of claim 42, further comprising:
the display device having the display screen that is configured to display a sixth user interface window including:
a plurality of UI cards displaying information on existing model analysis jobs;
with each UI card containing name and details of the existing model analysis jobs;
three pulldown menus to filter the existing model analysis jobs; and
a UI button in each UI card to visualize a corresponding model analysis job.
